(19) United States
(12) Patent Application Publication
(10) Pub. No.: US 2022/0341625 A1
(43) Pub. Date: Oct. 27, 2022

(54) BIOMASS HEATING SYSTEM, AS WELL AS ITS COMPONENTS

(71) Applicant: SL-TECHNIK GMBH, St. Pantaleon (AT)

(72) Inventor: Thilo SOMMERAUER, Gilgenberg am Weilhart (AT)

(73) Assignee: SL-TECHNIK GMBH, St. Pantaleon (AT)

(21) Appl. No.: 17/753,397

(22) PCT Filed: Sep. 3, 2020
(86) PCT No.: PCT/EP2020/074596

§ 371 Date: Mar. 2, 2022

(30) Foreign Application Priority Data
Sep. 3, 2019 (EP) 19195118.5
Nov. 19, 2019 (EP) 19210080.8
Nov. 20, 2019 (EP) 19210444.6

(51) Int. Cl. F24H 1/00; F23B 10/02; F23B 30/00; F23B 30/02; F24H 9/00; F23J 15/02; F23J 3/02; F23B 60/02; F24H 9/20; B03C 3/10; B03C 3/76

(52) U.S. Cl. CPC F24H 1/0063; F23B 10/02; F23B 1/24; F23B 30/02; F24H 9/0031; F23J 15/025; F23J 3/023; F23B 60/02; F24H 9/2057; B03C 3/10; B03C 3/76; F23M 2700/0053; F23J 2217/102

(57) ABSTRACT

A biomass heating system for burning fuel in the form of pellets and/or wood chips is disclosed, the system comprising the following: a boiler with a combustion device, a heat exchanger with a plurality of boiler tubes, wherein the combustion device comprises: a combustion chamber with a rotating grate, with a primary combustion zone and with a secondary combustion zone; wherein the primary combustion zone is enclosed by a plurality of combustion chamber bricks laterally and by the rotating grate from below; wherein a plurality of secondary air nozzles is provided in the combustion chamber bricks; wherein the primary combustion zone and the secondary combustion zone are separated at the level of the secondary air nozzles; wherein the secondary combustion zone of the combustion chamber is fluidically connected to an inlet of the heat exchanger.

### TECHNICAL FIELD

The invention relates to a biomass heating system, and to components thereof. In particular, the invention relates to a fluidically optimized biomass heating system.

### STATE OF THE ART

Biomass heating systems, especially biomass boilers, in a power range from 20 to 500 kW are known. Biomass can be considered a cheap, domestic, crisis-proof and environmentally friendly fuel. Combustible biomass or biogenic solid fuels include wood chips or pellets.

The pellets are usually made of wood chips, sawdust, biomass or other materials that have been compressed into small discs or cylinders with a diameter of approximately 3 to 15 mm and a length of 5 to 30 mm. Wood chips (also referred to as wood shavings, wood chips or wood chips) is wood shredded with cutting tools.

Biomass heating systems for fuels in the form of pellets and wood chips essentially feature a boiler with a combustion chamber (the combustion chamber) and with a heat exchange device connected to it. Due to stricter legal regulations in many countries, some biomass heating systems also feature a fine dust filter. Other various accessories are usually present, such as fuel delivery devices, control devices, probes, safety thermostats, pressure switches, a flue gas recirculation system, a boiler cleaning system, and a separate fuel tank.

The combustion chamber regularly includes a device for supplying fuel, a device for supplying air and an ignition device for the fuel. The device for supplying the air, in turn, usually features a low-pressure blower to advantageously influence the thermodynamic factors during combustion in the combustion chamber. A device for feeding fuel can be provided, for example, with a lateral insertion (so-called cross-insertion firing). In this process, the fuel is fed into the combustion chamber from the side via a screw or piston.

The combustion chamber of a fixed-bed furnace further typically includes a combustion grate on which fuel is substantially continuously fed and burned. This combustion grate stores the fuel for combustion and has openings, such as slots, that allow passage of a portion of the combustion air as primary air to the fuel. Furthermore, the grate can be unmovable or movable. In addition, there are grate furnaces, where the combustion air is supplied not through the grate, but only from the side.

When the primary air flows through the grate, the grate is also cooled, among other things, which protects the material. In addition, slag may form on the grate if the air supply is inadequate. In particular, furnaces that are to be fed with different fuels, with which the present disclosure is particularly concerned, have the inherent problem that the different fuels have different ash melting points, water contents and different combustion behavior. This makes it problematic to provide a heating system that is equally well suited for different fuels. The combustion chamber can be further regularly divided into a primary combustion zone (immediate combustion of the fuel on the grate as well as in the gas space above it before a further supply of combustion air) and a secondary combustion zone (post-combustion zone of the flue gas after a further supply of air). In the combustion chamber, drying, pyrolytic decomposition and gasification of the fuel and charcoal burnout take place. In order to completely burn the resulting combustible gases, additional combustion air is also introduced in one or more stages (secondary air or tertiary air) at the start of the secondary combustion zone.

After drying, the combustion of the pellets or wood chips has two main phases. In the first phase, the fuel is pyrolytically decomposed and converted into gas by high temperatures and air, which can be injected into the combustion chamber, and at least partially. In the second phase, combustion of the (in)part converted into gas occurs, as well as combustion of any remaining solids (for example, charcoal). In this respect, the fuel outgasses, and the resulting gas and the charcoal present in it are co-combusted.

Pyrolysis is the thermal decomposition of a solid substance in the absence of oxygen. Pyrolysis can be divided into primary and secondary pyrolysis. The products of primary pyrolysis are pyrolysis coke and pyrolysis gases, and pyrolysis gases can be divided into gases that can be condensed at room temperature and gases that cannot be condensed. Primary pyrolysis takes place at roughly 250-450° C. and secondary pyrolysis at about 450-600° C. The secondary pyrolysis that occurs subsequently is based on the further reaction of the pyrolysis products formed primarily. Drying and pyrolysis take place at least largely without the use of air, since volatile CH compounds escape from the particle and therefore no air reaches the particle surface. Gasification can be seen as part of oxidation; it is the solid, liquid and gaseous products formed during pyrolytic decomposition that are brought into reaction by further application of heat. This is done by adding a gasification agent such as air, oxygen, water vapor, or even carbon dioxide. The lambda value during gasification is greater than zero and less than one. Gasification takes place at around 300 to 850° C. or even up to 1,200° C. Complete oxidation with excess air (lambda greater than 1) takes place subsequently by further addition of air to these processes. The reaction end products are essentially carbon dioxide, water vapor and ash. In all phases, the boundaries are not rigid but fluid. The combustion process can be advantageously controlled by means of a lambda probe provided at the exhaust gas outlet of the boiler.

In general terms, the efficiency of combustion is increased by converting the pellets into gas, because gaseous fuel is better mixed with the combustion air and thus more completely converted, and a lower emission of pollutants, less unburned particles and ash (fly ash or dust particles) are produced.

The combustion of biomass produces gaseous or airborne combustion products whose main components are carbon, hydrogen and oxygen. These can be divided into emissions from complete oxidation, from incomplete oxidation and substances from trace elements or impurities. Emissions from complete oxidation are mainly carbon dioxide (CO2) and water vapor (H₂O). The formation of carbon dioxide from the carbon of biomass is the goal of combustion, as this allows the energy released to be used more fully. The release of carbon dioxide (CO2) is largely proportional to the carbon content of the amount of fuel burned; thus, the carbon dioxide is also dependent on the useful energy to be provided. A reduction can essentially only be achieved by improving efficiency.

However, the complex combustion processes described above are not easy to control. In general terms, there is a need for improvement in the combustion processes in biomass heating systems.

In addition to the air supply to the combustion chamber, exhaust gas recirculation devices are also known which return exhaust gas from the boiler to the combustion chamber for cooling and recombustion. In the prior art, there are usually openings in the combustion chamber for the supply of primary air through a primary air duct/passage feeding the combustion chamber, and there are also circumferential openings in the combustion chamber for the supply of secondary air from a secondary air passage/duct. Flue gas recirculation can take place under or above the grate. In addition, the flue gas recirculation can be mixed with the combustion air or performed separately.

The exhaust gas from the combustion in the combustion chamber is fed to the heat exchanger so that the hot combustion gases flow through the heat exchanger to transfer heat to a heat exchange medium, which is usually water at about 80° C. (usually between 70° C. and 110° C.). The boiler usually has a radiation section integrated into the combustion chamber and a convection section (the heat exchanger connected to it).

The ignition device is usually a hot air device or an annealing device. In the first case, combustion is initiated by supplying hot air to the combustion chamber, with the hot air being heated by an electrical resistor. In the second case, the ignition device has a glow plug/glow rod or multiple glow plugs to heat the pellets or wood chips by direct contact until combustion begins. The glow plugs may also be equipped with a motor to remain in contact with the pellets or wood chips during the ignition phase, and then retract so as not to remain exposed to the flames. This solution is prone to wear and is costly.

Basically, the problems with conventional biomass heating systems are that the gaseous or solid emissions are too high, the efficiency is too low, and the dust emissions are too high. Another problem is the varying quality of the fuel, due to the varying water content and the lumpiness of the fuel, which makes it difficult to burn the fuel evenly with low emissions. Especially for biomass heating systems, which are supposed to be suitable for different types of biological or biogenic fuel, the varying quality and consistency of the fuel makes it difficult to maintain a consistently high efficiency of the biomass heating system. There is considerable need for optimization in this respect.

A disadvantage of conventional biomass heating systems for pellets may be that pellets falling into the combustion chamber may roll or slide out of the grate or off the grate, or may land next to the grate and enter an area of the combustion chamber where the temperature is lower or where the air supply is poor, or they may even fall into the bottom chamber of the boiler or the ash chute. Pellets that do not remain on the grate or grate burn incompletely, causing poor efficiency, excessive ash and a certain amount of unburned pollutant particles. This applies to pellets as well as wood chips.

For this reason, the known biomass heating systems for pellets have baffle plates, for example, in the vicinity of the grate or grate and/or the outlet of the combustion gas, in order to retain fuel elements in certain locations. Some boilers have heels on the inside of the combustion chamber to prevent pellets from falling into the ash removal or/and the bottom chamber of the boiler. However, combustion residues can in turn become trapped in these baffles and offsets, which makes cleaning more difficult and can impede air flows in the combustion chamber, which in turn reduces efficiency. In addition, these baffle plates require their own manufacturing and assembly effort. This applies to pellets as well as wood chips.

Biomass heating systems for pellets or wood chips have the following additional disadvantages and problems.

There is also a problem of non-uniform distribution of pellets in the combustion chamber and especially on the grate, which reduces the efficiency of combustion and increases the emission of pollutants. This disadvantage can also hinder ignition if there is an area without fuel near the ignition device. This applies to pellets as well as wood chips.

Baffle plates or landings in the combustion chamber can limit this drawback and prevent the fuel from rolling or sliding off the grate or even falling into the bottom chamber of the boiler, but they obstruct the air flows and prevent optimal mixing of air and fuel.

Another problem is that incomplete combustion, as a result of non-uniform distribution of fuel from the grate and as a result of non-optimal mixing of air and fuel, favors the accumulation and falling of unburned ash through the air inlet openings leading directly onto the combustion grate or from the grate end into the air ducts or air supply area.

This is particularly disruptive and causes frequent interruptions to perform maintenance tasks such as cleaning. For all these reasons, a large excess of air is normally maintained in the combustion chamber, but this decreases the flame temperature and combustion efficiency, and results in increased emissions of unburned gases (e.g. CO, CyHy), NOx and dust (e.g. due to increased swirling).

The use of a blower with a low pressure head does not provide a suitable vortex flow of air in the combustion chamber and therefore does not allow an optimal mixing of air and fuel. In general, it is difficult to form an optimum vortex flow in conventional combustion chambers.

Another problem with the known burners without air staging is that the two phases, conversion of the pellets into gas and combustion, take place simultaneously in the entire combustion chamber by means of the same amount of air, which reduces efficiency.

Finally, some disadvantages exist in relation to the ignition devices. Hot air devices require high electrical power and incur high costs. Spark plugs require less power, but they need moving parts because the spark plugs must be motorized. They are expensive, complicated and can be a problem in terms of reliability.

Furthermore, there is a particular need for optimization of the heat exchangers of state-of-the-art biomass heating systems, i.e. their efficiency could be increased. There is also a need for improvement regarding the often cumbersome and inefficient cleaning of conventional heat exchangers.

The same applies to the usual electrostatic precipitators/filters of biomass heating systems. Their spray and also separator electrodes regularly get clogged with combustion residues, which worsens the formation of the electric field for filtration and reduces the efficiency of filtration.

It can be a task of the invention to provide a biomass heating system in hybrid technology, which is low in emissions (especially with regard to fine dust, CO, hydrocarbons, NOx), which can be operated flexibly with wood chips and pellets, and which has a high efficiency.

In accordance with the invention and in addition, the following considerations may playa role:

The hybrid technology should allow the use of both pellets and wood chips with water contents between 8 and 35 percent by weight.

The lowest possible gaseous emissions (less than 50 or 100 mg/Nm³ based on dry flue gas and 13 volume percent O2) are to be achieved.

Very low dust emissions of less than 15 mg/Nm³ without and less than 5 mg/Nm³ with electrostatic precipitator operation are targeted.

A high efficiency of up to 98% (based on the supplied fuel energy (calorific value) is to be achieved.

Further, one can take into account that the operation of the system should be optimized. For example, it should allow easy ash removal, easy cleaning, or easy maintenance.

In addition, there should be a high level of system availability.

In this context, the above-mentioned task or the potential individual problems can also relate to individual sub-aspects of the overall system, for example to the combustion chamber, the heat exchanger or the electrical filter device.

This task(s) is/are solved by the objects of the independent claims. Further aspects and advantageous further embodiments are the subject of the dependent claims.

According to another aspect of the present disclosure, a biomass heating system for burning fuel in the form of pellets and/or wood chips is disclosed, the system comprising the following: a boiler having a combustion device, a heat exchanger having a plurality of boiler tubes, the combustion device comprising the following: a combustion chamber with a rotating grate, with a primary combustion zone and with a secondary combustion zone; the primary combustion zone being enclosed by a plurality of combustion chamber bricks laterally and by the rotating grate from below; a plurality of secondary air nozzles being provided in the combustion chamber bricks; the primary combustion zone and the secondary combustion zone being separated at the level of the secondary air nozzles; the secondary combustion zone of the combustion chamber being fluidically connected to an inlet of the heat exchanger.

According to a further development of the foregoing, a biomass heating system is provided, wherein the secondary air nozzles are arranged such that vortex flows of a flue gas-air mixture of secondary air and combustion air about a vertical central axis are created in the secondary combustion zone of the combustion chamber, wherein the vortex flows lead to the improvement of the mixing of the flue gas-air mixture.

According to a further development, a biomass heating system is provided, wherein the secondary air nozzles in the combustion chamber bricks are each formed as a cylindrical or frustoconical opening in the combustion chamber bricks with a circular or elliptical cross-section, wherein the smallest diameter of the respective opening is smaller than its maximum length.

According to a further development, a biomass heating system is provided, wherein the combustion device with the combustion chamber is set up in such a way that the vortex flows form spiral rotational flows after exiting the combustion chamber nozzle, which extend up to a combustion chamber ceiling of the combustion chamber.

According to a further development, a biomass heating system is provided, wherein the secondary air nozzles are arranged in the combustion chamber at at least approximately the same height; and the secondary air nozzles are arranged with their central axis and/or aligned (depending on the type of nozzle) in such a way that the secondary air is introduced acentric to a center of symmetry of the combustion chamber.

According to a further development, a biomass heating system is provided, wherein the number of secondary air nozzles is between 8 and 14; and/or the secondary air nozzles have a minimum length of at least 50 mm with an inner diameter of 20 to 35 mm.

According to a further development, a biomass heating system is provided, wherein: the combustion chamber in the secondary combustion zone has a combustion chamber slope which reduces the cross section of the secondary combustion zone in the direction of the heat exchanger inlet.

According to a further development, a biomass heating system is provided, wherein the combustion chamber in the secondary combustion zone has a combustion chamber ceiling which is provided inclined upwards in the direction of the inlet of the heat exchanger, and which reduces the cross-section of the combustion chamber in the direction of the inlet.

According to a further development, a biomass heating system is provided, wherein the combustion chamber slope and the inclined combustion chamber ceiling form a funnel, the smaller end of which opens into the inlet of the heat exchanger.

According to a further development, a biomass heating system is provided, wherein the primary combustion zone and at least a part of the secondary combustion zone have an oval horizontal cross-section; and/or the secondary air nozzles are arranged to introduce the secondary air tangentially into the combustion chamber.

According to a further development, a biomass heating system is provided, wherein the average flow velocity of the secondary air in the secondary air nozzles is at least 8 m/s, preferably at least 10 m/s.

According to a further development, a biomass heating system is provided, wherein the combustion chamber bricks have a modular structure; and each two semicircular combustion chamber bricks form a closed ring to form the primary combustion zone and/or a part of the secondary combustion zone; and at least two rings of combustion chamber bricks are arranged stacked on top of each other.

According to a further embodiment, a biomass heating system is provided, wherein the heat exchanger comprises spiral turbulators disposed in the boiler tubes and extending along the entire length of the boiler tubes; and the heat exchanger comprises band turbulators disposed in the boiler tubes and extending along at least half the length of the boiler tubes.

According to another aspect of the present disclosure, there is provided a biomass heating system for burning fuel in the form of pellets and/or wood chips, comprising: a boiler having a combustion device, a heat exchanger having a plurality of boiler tubes, preferably arranged in a bundle, wherein the combustion device comprises: a combustion chamber having a rotating grate and having a primary combustion zone and having a secondary combustion zone, preferably provided above the primary combustion zone; wherein the primary combustion zone is encompassed by a plurality of combustion chamber bricks laterally and by the rotating grate from below; wherein secondary combustion zone includes a combustion chamber nozzle or the secondary combustion zone of the combustion chamber being fluidly connected to an inlet of the heat exchanger; the primary combustion zone having an oval horizontal cross section.

Boiler tubes arranged in bundles may be a plurality of boiler tubes arranged parallel to each other and having at least substantially the same length. Preferably, the inlet openings and the outlet openings of all boiler tubes can each be arranged in a common plane; i.e., the inlet openings and the outlet openings of all boiler tubes are at the same height.

“Horizontal” in this context may refer to a flat orientation of an axis or a cross-section on the assumption that the boiler is also installed horizontally, whereby the ground level may be the reference, for example. Alternatively, “horizontal” can mean “parallel” to the base plane of the boiler 11, as this is usually defined. Further alternatively, particularly in the absence of a reference plane, “horizontal” may be understood to mean merely “parallel” to the combustion plane of the grate.

Further, the primary combustion zone may have an oval cross-section.

The oval horizontal cross-section has no dead corners, and thus exhibits improved air flow and the possibility of largely unimpeded vortex/swirling flow. Consequently, the biomass heating system has improved efficiency and lower emissions. In addition, the oval cross-section is well adapted to the type of fuel distribution with lateral feeding of the latter and the resulting geometry of the fuel bed on the grate. An ideally “round” cross-section is also possible, but not so well adapted to the geometry of the fuel distribution and also to the fluid dynamics of the vortex flow, the asymmetry of the oval compared to the “ideal” circular cross-sectional shape of the combustion chamber allowing improved formation of turbulent flow in the combustion chamber.

According to a further development, a biomass heating system is provided, wherein the horizontal cross-section of the primary combustion zone is provided to be at least approximately constant over a height of at least 100 mm. This also serves to ensure the unimpeded formation of the flow profiles in the combustion chamber.

According to a further development, a biomass heating system is provided, wherein the combustion chamber in the secondary combustion zone has a combustion chamber slope which tapers the cross-section of the secondary combustion zone in the direction of the inlet or intake of the heat exchanger.

According to a further development, a biomass heating system is provided, wherein the rotating grate comprises a first rotating grate element, a second rotating grate element and a third rotating grate element, which are each arranged rotatably about a horizontally arranged bearing axis by at least 90 degrees, preferably at least 160 degrees, even more preferably by at least 170 degrees; wherein the rotating grate elements form a combustion area for the fuel; wherein the rotating grate elements comprise openings for the air for combustion, wherein the first rotating grate element and the third rotating grate element are formed identically in their combustion area.

The openings in the rotating grate elements are preferably slit-shaped and formed in a regular pattern to ensure uniform air flow through the fuel bed.

According to a further development, a biomass heating system is provided, wherein the second rotating grate element is arranged in a form-fitting manner between the first rotating grate element and the third rotating grate element and has grate lips which are arranged in such a way that, in the horizontal position of all three rotating grate elements, they bear against the first rotating grate element and the third rotating grate element in an at least largely sealing manner.

According to a further embodiment, a biomass heating system is provided, wherein the rotating grate further comprises a rotating grate mechanism configured to rotate the third rotating grate member independently of the first rotating grate member and the second rotating grate member, and to rotate the first rotating grate member and the second rotating grate member together but independently of the third rotating grate member.

According to a further embodiment, a biomass heating system is provided wherein the combustion area of the rotating grate elements configures a substantially oval or elliptical combustion area.

According to a further embodiment, a biomass heating system is provided wherein the rotating grate members have complementary and curved sides, preferably the second rotating grate member has concave sides respectively towards the adjacent first and third rotating grate members, and preferably the first and third rotating grate members have convex sides respectively towards the second rotating grate member.

According to a further development, a biomass heating system is provided, wherein the combustion chamber bricks have a modular structure; and each two semicircular combustion chamber bricks form a closed ring to form the primary combustion zone; and at least two rings of combustion chamber bricks are arranged stacked on top of each other.

According to a further embodiment, a biomass heating system is provided, wherein the heat exchanger comprises spiral turbulators disposed in the boiler tubes and extending along the entire length of the boiler tubes; and the heat exchanger comprises band turbulators disposed in the boiler tubes and extending along at least half the length of the boiler tubes. Preferably, the band turbulators can be arranged in or inside the spiral turbulators. In particular, the band turbulators can be arranged integrated in the spiral turbulators. Preferably, the band turbulators can extend over a length of 30% to 70% of the length of the spiral turbulators.

According to a further development, a biomass heating system is provided, wherein the heat exchanger comprises between 18 and 24 boiler tubes, each having a diameter of 70 to 85 mm and a wall thickness of 3 to 4 mm.

According to a further development, a biomass heating system is provided, wherein the boiler comprises an integrally arranged electrostatic filter device comprising a spray electrode and a collecting electrode surrounding the spray electrode and a cage or cage-shaped cleaning device; wherein the boiler further comprises a mechanically operable cleaning device comprising an impact lever with an impact/stop head; wherein the cleaning device is arranged to impact the (spray) electrode at its end with the impact head, so that a shock wave is generated by the electrode and/or a transverse vibration of the (spray) electrode to clean the electrode from impurities. The material for the electrode is a steel which can be vibrated (longitudinally and/or transversely and/or shock wave) by the stop head. For example, spring steel and/or chrome steel can be used for this purpose. The material of the spring steel can preferably be an austenitic chromium-nickel steel, for example 1.4310. Furthermore, the spring steel can be cambered. The cage-shaped cleaning device can be further reciprocated along the wall of the electrostatic filter device for cleaning the collecting electrode.

According to a further development, a biomass heating system is provided, wherein a cleaning device integrated into the boiler in the cold area is provided, which is configured such that it can clean the boiler tubes of the heat exchanger by an upward and downward movement of turbulators provided in the boiler tubes. The up and down movement can also be understood as the back and forth movement of the turbulators in the boiler tubes in the longitudinal direction of the boiler tubes.

According to a further development, a biomass heating system is provided, wherein a glow bed height measuring mechanism is arranged in the combustion chamber above the rotating grate; wherein the glow bed height measuring mechanism comprises a fuel level flap mounted on a rotation axis and having a main surface/area; wherein a surface parallel of the main surface of the fuel level flap is provided at an angle to a central axis of the rotary axis, the angle preferably being greater than 20 degrees.

Although all of the foregoing individual features and details of an aspect of the invention and embodiments of that aspect are described in connection with the biomass heating system, those individual features and details are also disclosed as such independently of the biomass heating system.

For example, a combustion chamber slope of a secondary combustion zone of a combustion chamber having the features and characteristics thereof disclosed herein is disclosed which is suitable for a biomass heating system (only). In this respect, a combustion chamber slope for a secondary combustion zone of a combustion chamber of a biomass heating system having the features and characteristics disclosed herein is disclosed.

Further disclosed, for example, is a rotating grate for a combustion chamber of a biomass heating system having the features and characteristics thereof disclosed herein.

Further disclosed, for example, is a plurality of combustion chamber bricks for a combustion chamber of a biomass heating system having the features and characteristics thereof disclosed herein.

Further disclosed, for example, is an integrated electrostatic filter device for a biomass heating system having the features and characteristics thereof disclosed herein.

Further disclosed, for example, is a plurality of boiler tubes for a biomass heating system having features and characteristics thereof as disclosed herein.

Further disclosed, for example, is a glow bed height measuring mechanism for a biomass heating system having features and characteristics as disclosed herein.

Further disclosed, for example, is likewise, as such, a fuel level flap for a biomass heating system having the features and characteristics thereof disclosed herein.

The biomass heating system according to the invention is explained in more detail below in exemplary embodiments and individual aspects based on the figures of this specification:

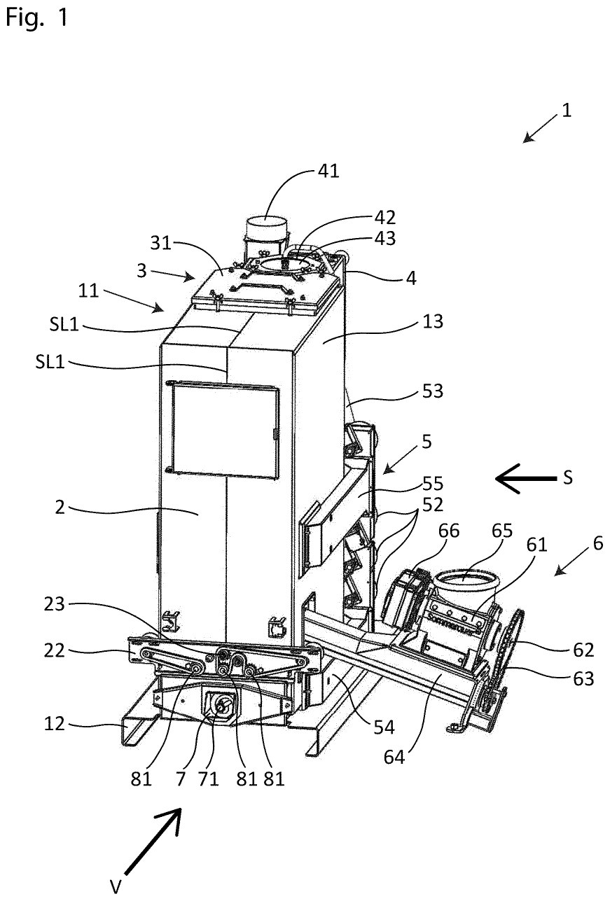

FIG. 1 shows a three-dimensional overview view of a biomass heating system according to one embodiment of the invention;

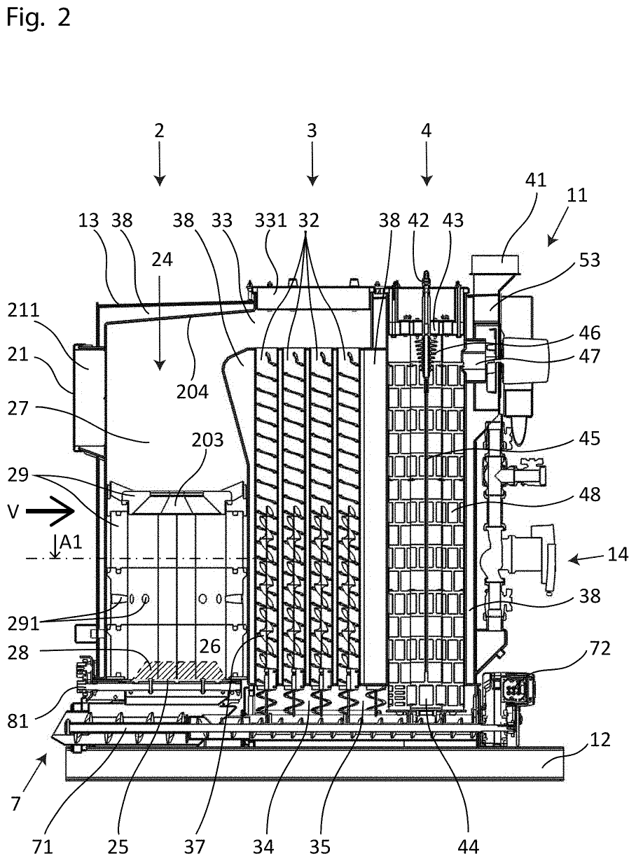

FIG. 2 shows a cross-sectional view through the biomass heating system of FIG. 1, which was made along a section line SL1 and which is shown as viewed from the side view S;

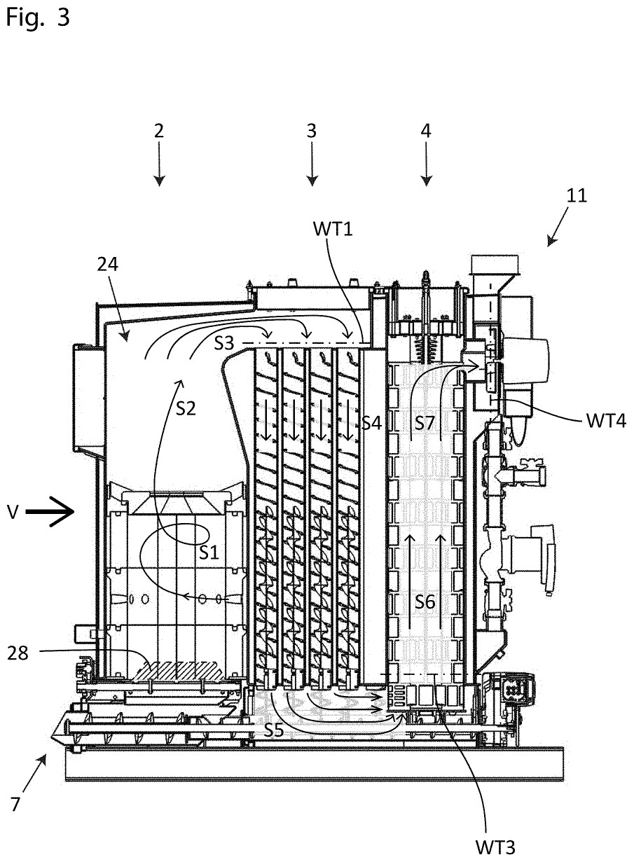

FIG. 3 also shows a cross-sectional view through the biomass heating system of FIG. 1 with a representation of the flow course, the cross-sectional view having been made along a section line SL1 and being shown as viewed from the side view S;

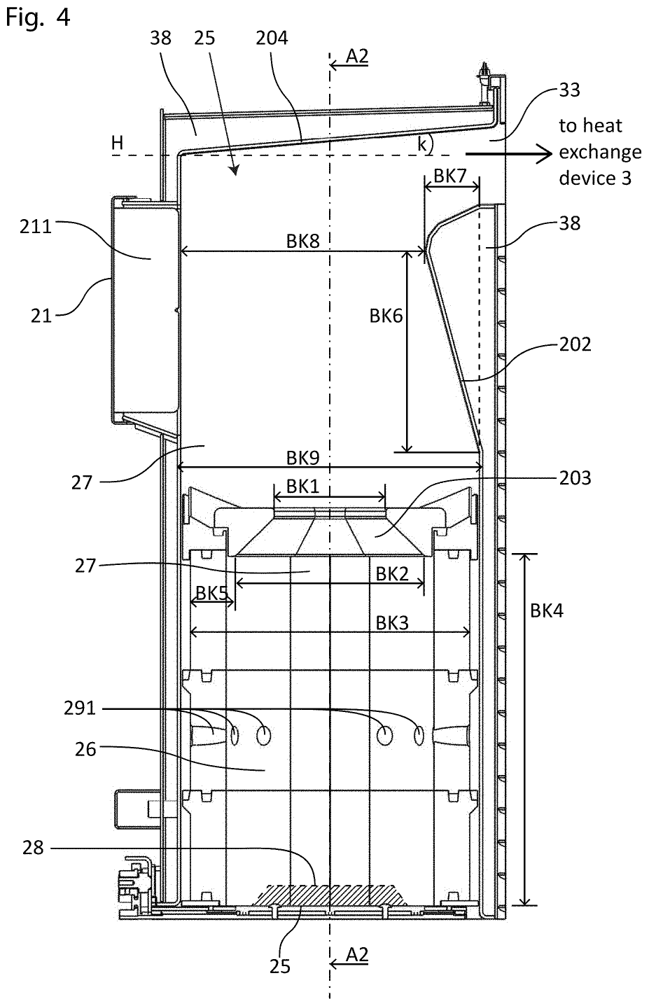

FIG. 4 shows a partial view of FIG. 2, depicting a combustion chamber geometry of the boiler of FIG. 2 and FIG. 3;

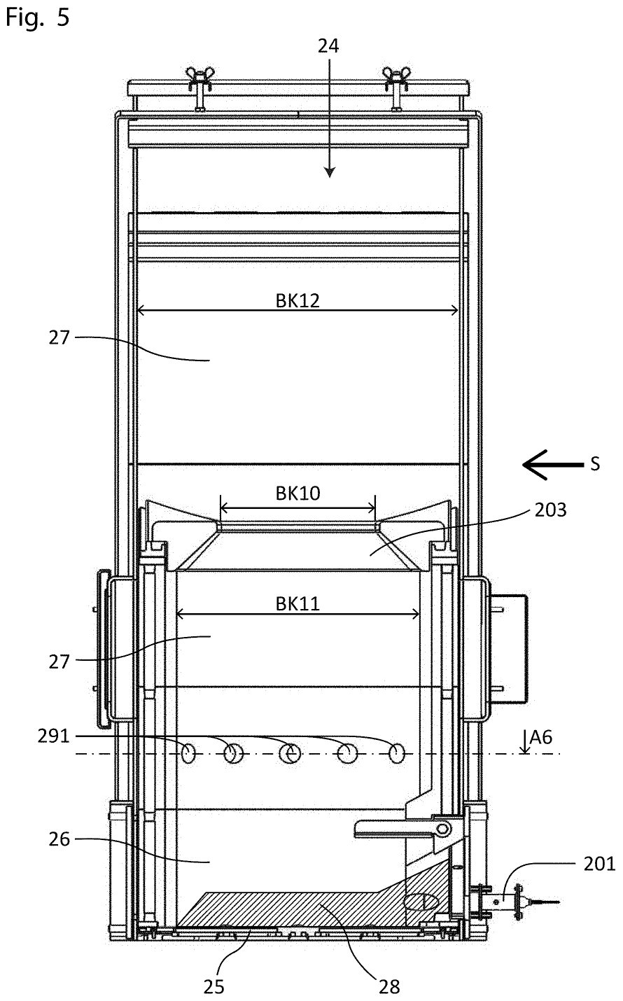

FIG. 5 shows a sectional view through the boiler or the combustion chamber of the boiler along the vertical section line A2 of FIG. 4;

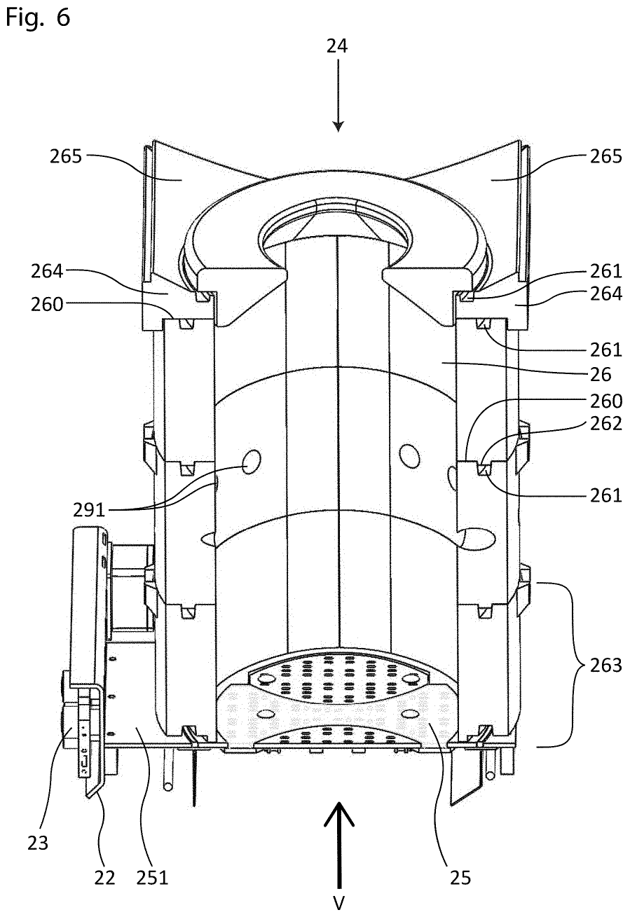

FIG. 6 shows a three-dimensional sectional view of the primary combustion zone of the combustion chamber with the rotating grate of FIG. 4;

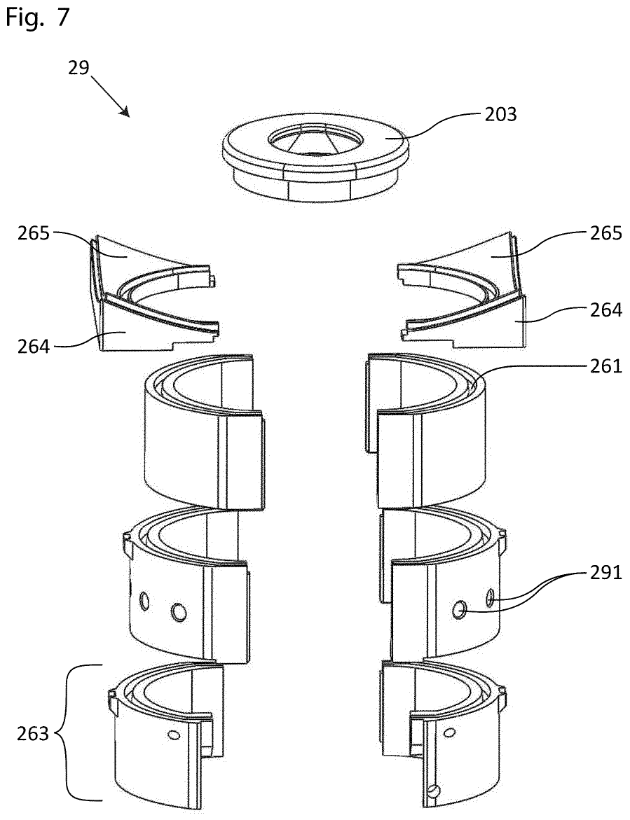

FIG. 7 shows an exploded view of the combustion chamber bricks as in FIG. 6;

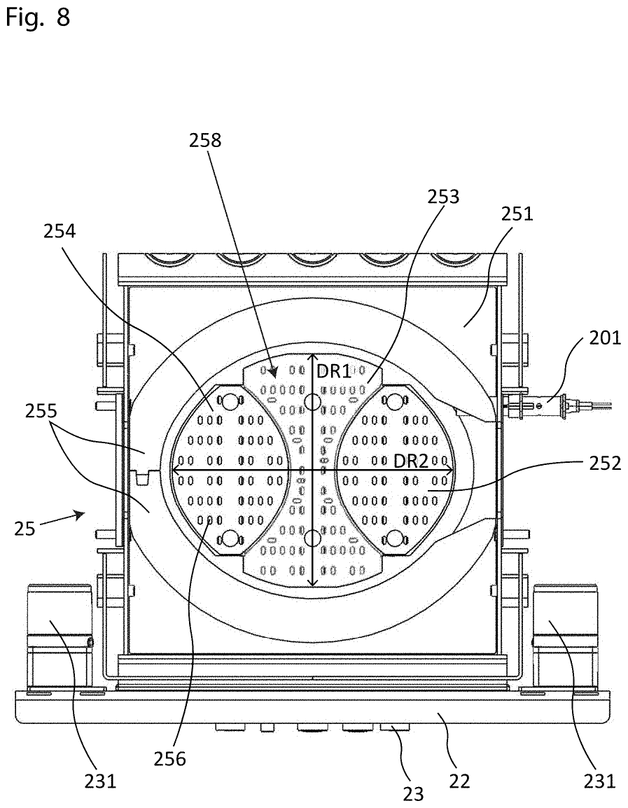

FIG. 8 shows a top view of the rotating grate with rotating grate elements as seen from section line A1 of FIG. 2;

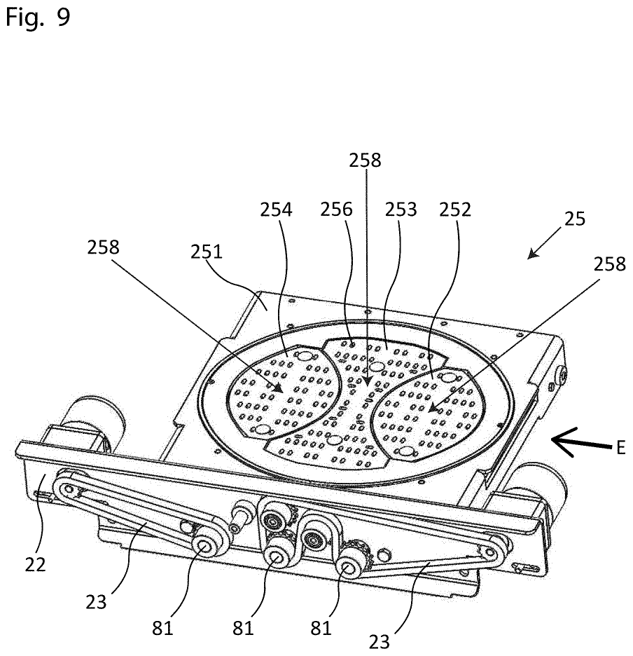

FIG. 9 shows the rotating grate of FIG. 2 in closed position, with all rotating grate elements horizontally aligned or closed;

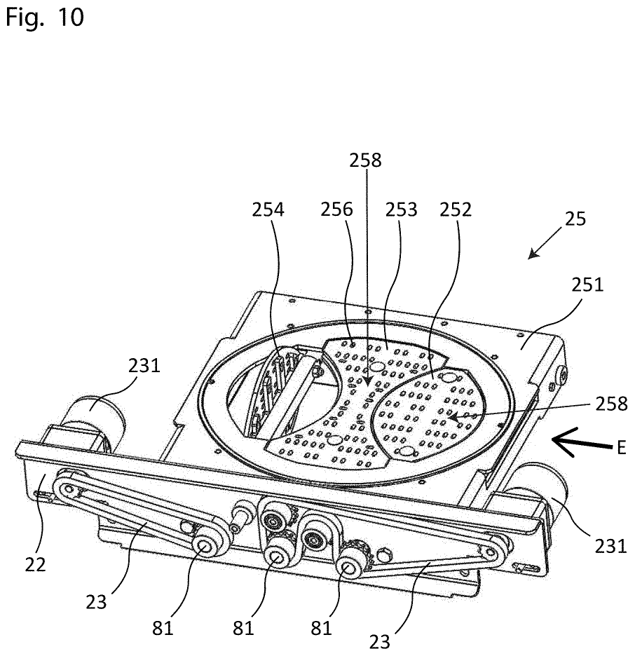

FIG. 10 shows the rotating grate of FIG. 9 in the state of partial cleaning of the rotating grate in glow maintenance mode;

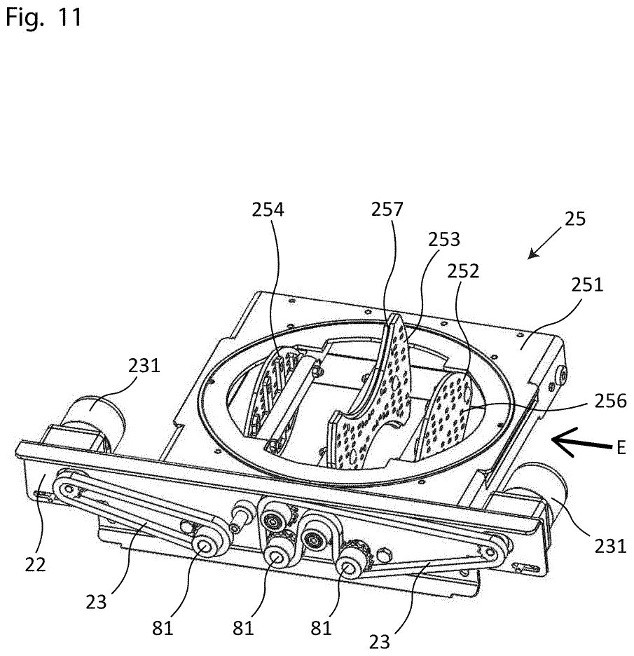

FIG. 11 shows the rotating grate of FIG. 9 in the state of universal cleaning, which is preferably carried out during a system shutdown;

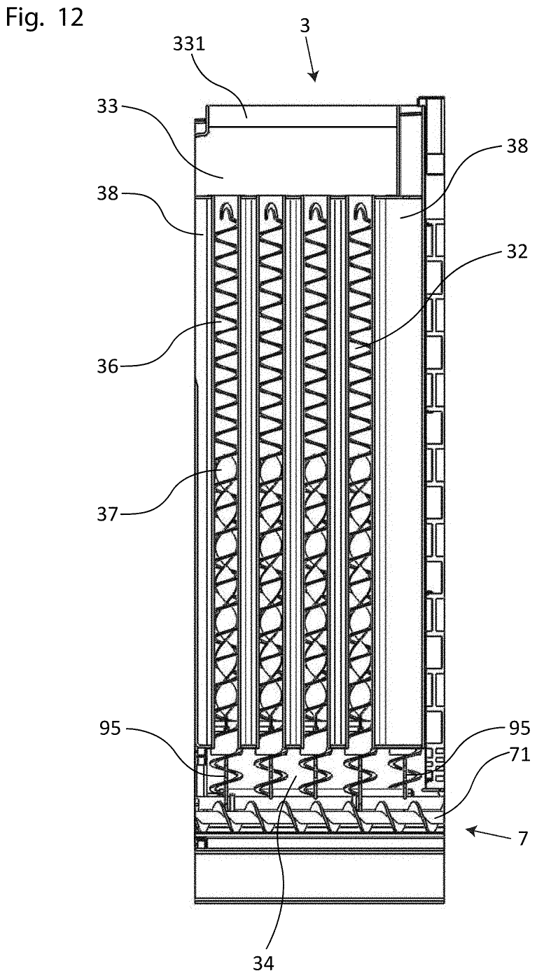

FIG. 12 shows a cutaway detail view of FIG. 2;

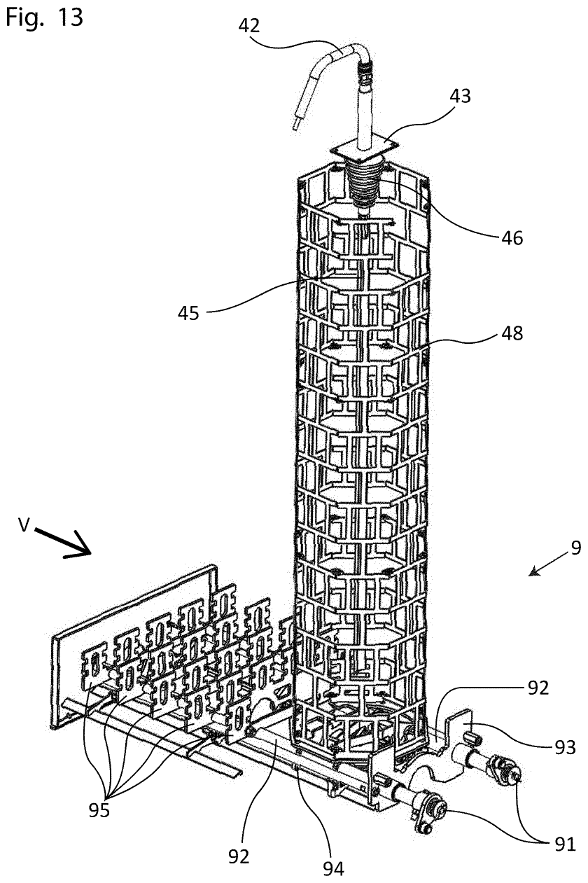

FIG. 13 shows a cleaning device with which both the heat exchanger and the filter device of FIG. 2 can be cleaned automatically;

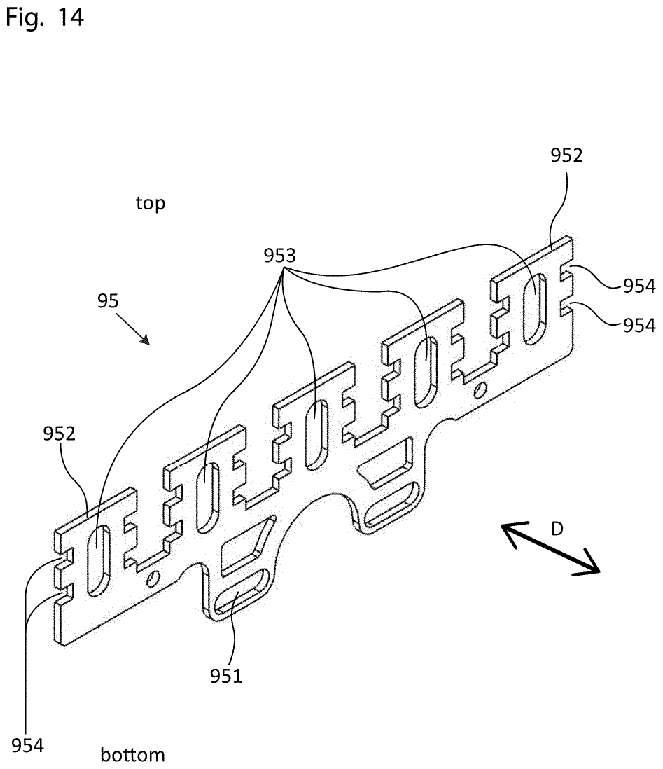

FIG. 14 shows a turbulator holder in a highlighted and enlarged form;

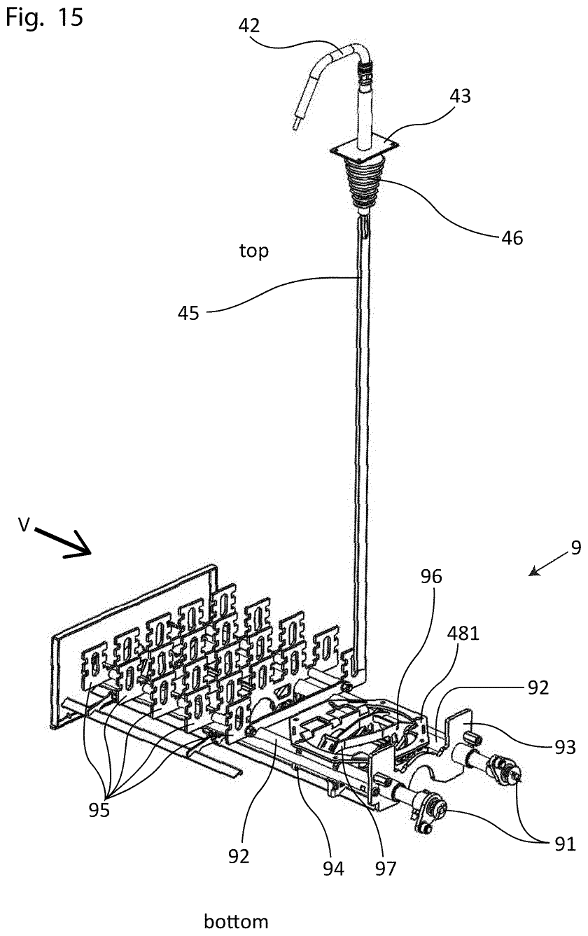

FIG. 15 shows a cleaning mechanism in a first state, with both the turbulator brackets/turbulator mounts of FIG. 14 and a cage mount in a down position;

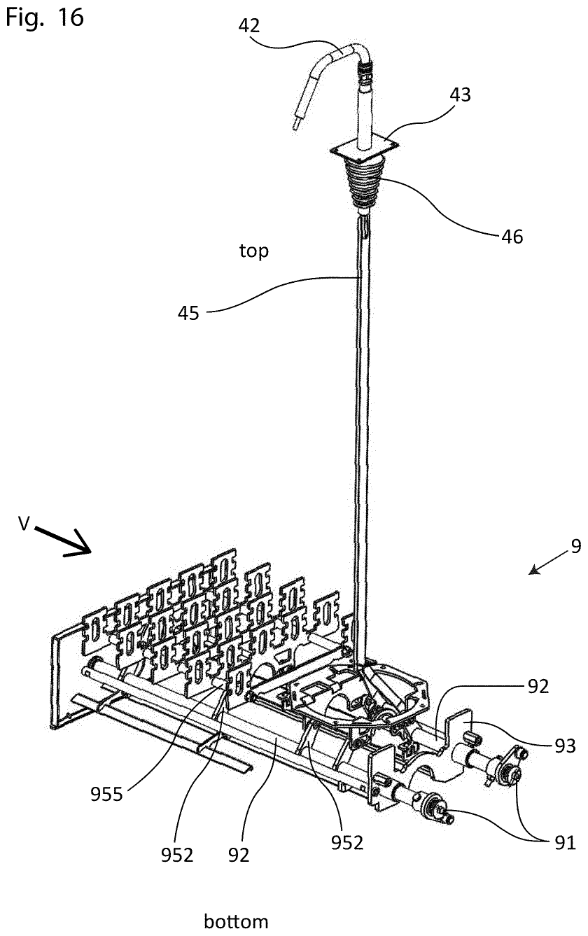

FIG. 16 shows the cleaning mechanism in a second state, with both the turbulator mounts of FIG. 14 and the cage mount in an up position;

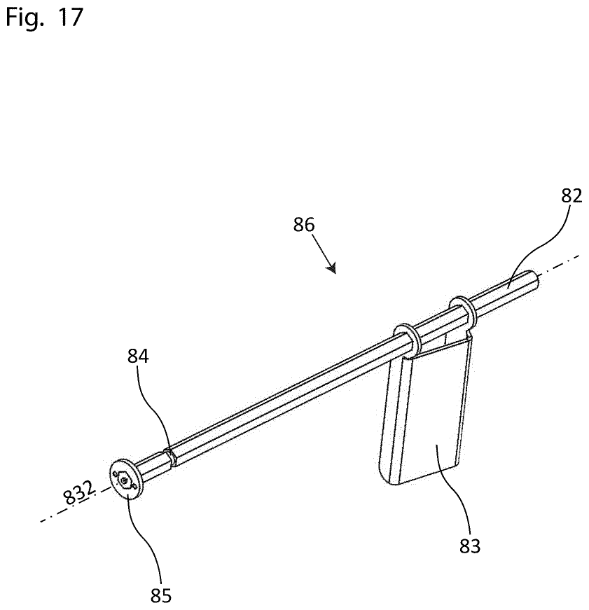

FIG. 17 shows an exposed glow bed height measurement mechanism with a fuel level flap;

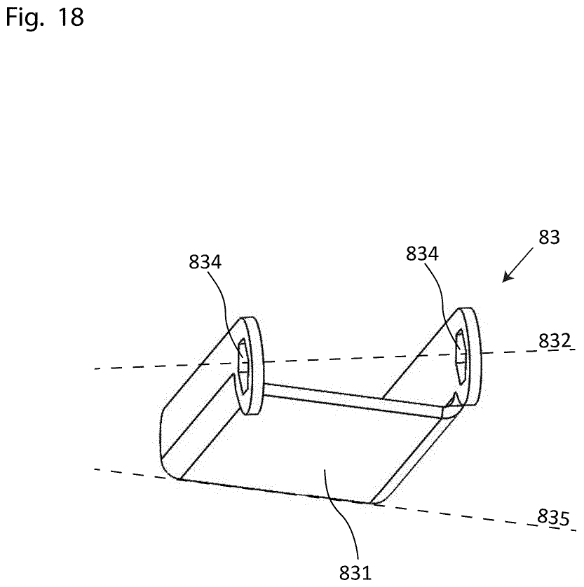

FIG. 18 shows a detailed view of the fuel level flap;

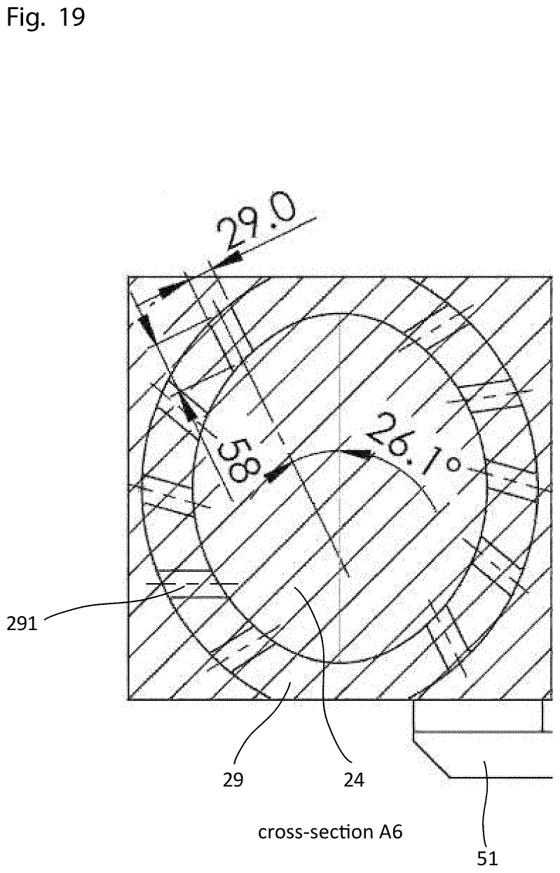

FIG. 19 shows a horizontal cross-sectional view through the combustion chamber at the level of the secondary air nozzles;

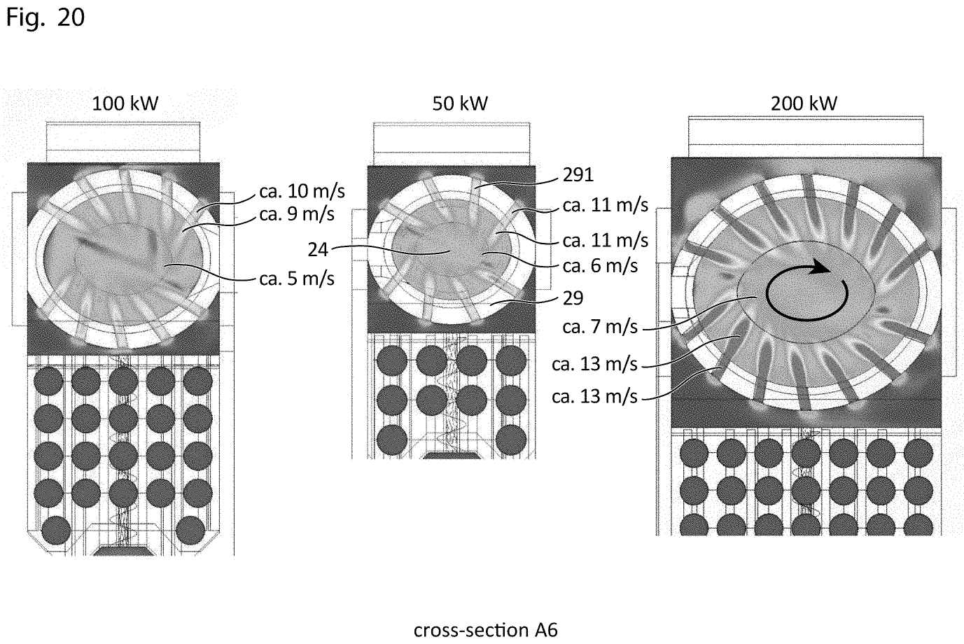

FIG. 20 shows three horizontal cross-sectional views for different boiler dimensions through the combustion chamber at the level of the secondary air nozzles with details of the flow distributions in this cross-section;

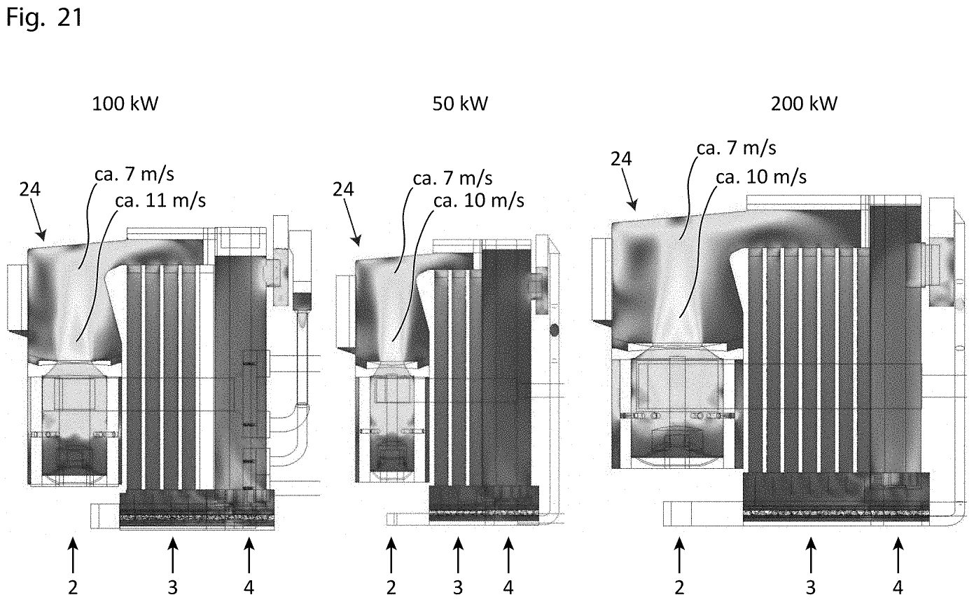

FIG. 21 shows three vertical cross-sectional views for different boiler dimensions through the biomass heating system along section line SL1 of FIG. 1, with details of the flow distributions in this cross-section.

### DESCRIPTION OF EXEMPLARY EMBODIMENTS

In the following, various embodiments of the present disclosure are disclosed with reference to the accompanying drawings by way of example only. However, embodiments and terms used therein are not intended to limit the present disclosure to particular embodiments and should be construed to include various modifications, equivalents, and/or alternatives in accordance with embodiments of the present disclosure.

Should more general terms be used in the description for features or elements shown in the figures, it is intended that for the person skilled in the art not only the specific feature or element is disclosed in the figures, but also the more general technical teaching.

With reference to the description of the figures the same reference signs may be used in each figure to refer to similar or technically corresponding elements. Furthermore, for the sake of clarity, more elements or features can be shown with reference signs in individual detail or section views than in the overview views. It can be assumed that these elements or features are also disclosed accordingly in the overview presentations, even if they are not explicitly listed there.

It should be understood that a singular form of a noun corresponding to an object may include one or more of the things, unless the context in question clearly indicates otherwise.

In the present disclosure, an expression such as “A or B”, “at least one of “A or/and B”, or “one or more of A or/and B” may include all possible combinations of features listed together. Expressions such as “first,” “second,” “primary,” or “secondary” used herein may represent different elements regardless of their order and/or meaning and do not limit corresponding elements. When an element (e.g., a first element) is described as being “operably” or “communicatively” coupled or connected to another element (e.g., a second element), the element may be directly connected to the other element or may be connected to the other element via another element (e.g., a third element).

For example, a term “configured to” (or “set up”) used in the present disclosure may be replaced with “suitable for,” “adapted to,” “made to,” “capable of,” or “designed to,” as technically possible. Alternatively, in a particular situation, an expression “device configured to” or “set up to” may mean that the device can operate in conjunction with another device or component, or perform a corresponding function.

All size specifications, which are given in “mm”, are to be understood as a size range of +−1 mm around the specified value, unless another tolerance or other ranges are explicitly specified. All dimensions and sizes are only exemplary.

It should be noted that the present individual aspects, for example, the rotating grate, the combustion chamber, or the filter device are disclosed separately from or apart from the biomass heating system herein as individual parts or individual devices. It is thus clear to the person skilled in the art that individual aspects or system parts are also disclosed herein even in isolation. In the present case, the individual aspects or parts of the system are disclosed in particular in the subchapters marked by brackets. It is envisaged that these individual aspects can also be claimed separately.

Further, for the sake of clarity, not all features and elements are individually designated in the figures, especially if they are repeated. Rather, the elements and features are each designated by way of example. Analog or equal elements are then to be understood as such.

(Biomass Heating System)

FIG. 1 shows a three-dimensional overview view of the biomass heating system 1 according to an exemplary embodiment of the invention.

In the figures, the arrow V denotes the front view of the system 1, and the arrow S denotes the side view of the system 1 in the figures.

The biomass heating system 1 has a boiler 11 supported on a boiler base 12. The boiler 11 has a boiler housing 13, for example made of sheet steel.

In the front part of the boiler 11 there is a combustion device 2 (not shown), which can be reached via a first maintenance opening with a shutter 21. A rotary mechanism mount 22 for a rotating grate 25 (not shown) supports a rotary mechanism 23, which can be used to transmit drive forces to bearing axles 81 of the rotating grate 25.

In the central part of the boiler 11 there is a heat exchanger 3 (not shown), which can be reached from above via a second maintenance opening with a shutter 31.

In the rear of the boiler 11 is an optional filter device 4 (not shown) with an electrode 44 (not shown) suspended by an insulating electrode support 43, which is energized by an electrode supply line 42. The exhaust gas from the biomass heating system 1 is discharged via an exhaust gas outlet 41, which is arranged downstream of the filter device 4 in terms of flow. A fan may be provided here.

A recirculation device 5 is provided downstream of the boiler 11 to recirculate a portion of the exhaust gas through recirculation ducts 51, 53 and 54 and flaps 52 for cooling of the combustion process and reuse in the combustion process.

Further, the biomass heating system 1 has a fuel supply 6 by which the fuel is conveyed in a controlled manner to the combustion device 2 in the primary combustion zone 26 from the side onto the rotating grate 25. The fuel supply 6 has a rotary valve 61 with a fuel supply opening/port 65, the rotary valve 61 having a drive motor 66 with control electronics. An axle 62 driven by the drive motor 66 drives a translation mechanism 63, which can drive a fuel feed screw 67 (not shown) so that fuel is fed to the combustion device 2 in a fuel feed channel 64.

In the lower part of the biomass heating system 1, an ash removal/discharge device 7 is provided, which has an ash discharge screw 71 in an ash discharge channel operated by a motor 72.

FIG. 2 now shows a cross-sectional view through the biomass heating system 1 of FIG. 1, which has been made along a section line SL1 and which is shown as viewed from the side view S. In the corresponding FIG. 3, which shows the same section as FIG. 2, the flows of the flue gas, and fluidic cross-sections are shown schematically for clarity. With regard to FIG. 3, it should be noted that individual areas are shown dimmed in comparison to FIG. 2. This is only for clarity of FIG. 3 and visibility of flow arrows S5, S6 and S7.

From left to right, FIG. 2 shows the combustion device 2, the heat exchanger 3 and an (optional) filter device 4 of the boiler 11. The boiler 11 is supported on the boiler base/foot 12, and has a multi-walled boiler housing 13 in which water or other fluid heat exchange medium can circulate. A water circulation device 14 with pump, valves, pipes, etc. is provided for supplying and discharging the heat exchange medium.

The combustion device 2 has a combustion chamber 24 in which the combustion process of the fuel takes place in the core. The combustion chamber 24 has a multi-piece rotating grate 25, explained in more detail later, on which the fuel bed 28 rests. The multi-part rotating grate 25 is rotatably mounted by means of a plurality of bearing axles 81.

Further referring to FIG. 2, the primary combustion zone 26 of the combustion chamber 24 is enclosed by (a plurality of) combustion chamber brick(s) 29, whereby the combustion chamber bricks 29 define the geometry of the primary combustion zone 26. The cross-section of the primary combustion zone 26 (for example) along the horizontal section line A1 is substantially oval (for example 380 mm+−60 mm×320 mm+−60 mm; it should be noted that some of the above size combinations may also result in a circular cross-section). The arrow S1 schematically represents the flow from the secondary air nozzle 291, this flow (this is purely schematic) having a swirl induced by the secondary air nozzles 291 to improve the mixing of the flue gas.

The secondary air nozzles 291 are designed in such a way that they introduce the secondary air (preheated by the combustion chamber bricks 29) tangentially into the combustion chamber 24 with its oval cross section (see FIG. 19). This creates a vortex or swirl-like flow S1, which runs roughly upwards in a spiral or helix shape. In other words, a spiral flow is formed that runs upward and rotates about a vertical axis.

The combustion chamber bricks 29 form the inner lining of the primary combustion zone 26, store heat and are directly exposed to the fire. Thus, the combustion chamber bricks 29 also protect the other material of the combustion chamber 24, such as cast iron, from direct flame exposure in the combustion chamber 24. The combustion chamber bricks 29 are preferably adapted to the shape of the grate 25. The combustion chamber bricks 29 further include secondary air or recirculation nozzles 291 that recirculate the flue gas into the primary combustion zone 26 for renewed participation in the combustion process and, in particular, for cooling as needed. In this regard, the secondary air nozzles 291 are not oriented toward the center of the primary combustion zone 26, but are oriented off-center to create a swirl of flow in the primary combustion zone 26 (i.e., a swirl and vortex flow, which will be discussed in more detail later). The combustion chamber bricks 29 will be discussed in more detail later. Insulation 311 is provided at the boiler tube inlet. The oval cross-sectional shape of the primary combustion zone 26 (and nozzle) and the length and location of the secondary air nozzles 291 advantageously promote the formation and maintenance of a vortex flow preferably to the ceiling of the combustion chamber 24.

A secondary combustion zone 27 joins, either at the level of the combustion chamber nozzles 291 (considered functionally or combustion-wise) or at the level of the combustion chamber nozzle 203 (considered purely structurally or construction-wise), the primary combustion zone 26 of the combustion chamber 26 and defines the radiation portion of the combustion chamber 26. In the radiation section, the flue gas produced during combustion gives off its thermal energy mainly by thermal radiation, in particular to the heat exchange medium, which is located in the two left chambers for the heat exchange medium 38. The corresponding flue gas flows are indicated in FIG. 3 by arrows S2 and S3 purely as examples. These vortex flows will possibly also include slight backflows or further turbulence, which are not represented by the purely schematic arrows S2 and S3. However, the basic principle of the flow characteristics in the combustion chamber 24 is clear or calculable to the person skilled in the art based on the arrows S2 and S3.

Caused by the secondary air injection, pronounced swirl or rotation or vortex flows (cf. FIG. 20 for the beginning of the vortex flows at the level of the secondary nozzles 291) are formed in the isolated or confined combustion chamber 24. In particular, the oval combustion chamber geometry 24 helps to ensure that the vortex flow can develop undisturbed or optimally.

After exiting the nozzle 203, which bundles these vortex flows once again, candle flame-shaped rotational flows S2 appear (cf. also FIG. 21), which can advantageously extend to the combustion chamber ceiling 204, thus making better use of the available space of the combustion chamber 24. In this case, the vortex flows are concentrated on the combustion chamber center A2 and make ideal use of the volume of the secondary combustion zone 27. Further, the constriction that combustion chamber nozzle 203 presents to the vortex flows mitigates the rotational flows, thereby creating turbulence to improve the mixing of the air-flue gas mixture. Thus, cross-mixing occurs due to the constriction or narrowing by the combustion chamber nozzle 203. However, the rotational momentum of the flows is maintained, at least in part, above the combustion chamber nozzle 203, which maintains the propagation of these flows to the combustion chamber ceiling 204.

The secondary air nozzles 291 are thus integrated into the elliptical or oval cross-section of the combustion chamber 24 in such a way that, due to their length and orientation, they induce vortex flows which cause the flue gas-secondary air mixture to rotate, thereby enabling (again enhanced by in combination with the combustion chamber nozzle 203 positioned above) complete combustion with minimum excess air and thus maximum efficiency. This is also illustrated in FIGS. 19 to 21.

The secondary air supply is designed in such a way that it cools the hot combustion chamber bricks 29 by flowing around them and the secondary air itself is preheated in return, thus accelerating the burnout rate of the flue gases and ensuring the completeness of the burnout even at extreme partial loads (e.g. 30% of the nominal load).

The first maintenance opening 21 is insulated with an insulation material, for example Vermiculite™. The present secondary combustion zone 27 is arranged to ensure burnout of the flue gas. The specific geometric design of the secondary combustion zone 27 will be discussed in more detail later.

After the secondary combustion zone 27, the flue gas flows into the heat exchange device 3, which has a bundle of boiler tubes 32 provided parallel to each other. The flue gas now flows downward in the boiler tubes 32, as indicated by arrows S4 in FIG. 3. This part of the flow can also be referred to as the convection part, since the heat dissipation of the flue gas essentially occurs at the boiler tube walls via forced convection. Due to the temperature gradients caused in the boiler 11 in the heat exchange medium, for example in the water, a natural convection of the water is established, which favors a mixing of the boiler water.

Spring turbulators 36 and spiral or band turbulators 37 are arranged in the boiler tubes 32 to improve the efficiency of the heat exchange device 4. This will be explained in more detail later.

The outlet of the boiler tubes 32 opens via the reversing chamber inlet 34 resp.-inlet into the turning chamber 35. If the filter device 4 is not provided, the flue gas is discharged upwards again in the boiler 11. The other case of the optional filter device 4 is shown in FIGS. 2 and 3. After the turning chamber 35, the flue gas is fed back upwards into the filter device 4 (see arrows S5), which in this example is an electrostatic filter device 4. Flow baffles can be provided at the inlet 44 of the filter device 4, which even out the flow of the flue gas into the filter.

Electrostatic dust collectors, or electrostatic precipitators, are devices for separating particles from gases based on the electrostatic principle. These filter devices are used in particular for the electrical cleaning of exhaust gases. In electrostatic precipitators, dust particles are electrically charged by a corona discharge of a spray electrode and drawn to the oppositely charged electrode (collecting electrode). The corona discharge takes place on a charged high-voltage electrode (also known as a spray electrode) inside the electrostatic precipitator that is suitable for this purpose. The electrode is preferably designed with protruding tips and possibly sharp edges, because the density of the field lines and thus also the electric field strength is greatest there and thus corona discharge is favored. The opposed electrode (precipitation electrode) usually consists of a grounded exhaust pipe section supported around the electrode. The separation efficiency of an electrostatic precipitator depends in particular on the residence time of the exhaust gases in the filter system and the voltage between the spray electrode and the separation electrode. The rectified high voltage required for this is provided by a high-voltage generation device (not shown). The high-voltage generation system and the holder for the electrode must be protected from dust and contamination to prevent unwanted leakage currents and to extend the service life of system 1.

As shown in FIG. 2, a rod-shaped electrode 45 (which is preferably shaped like an elongated, plate-shaped steel spring, cf. FIG. 15) is supported approximately centrally in an approximately chimney-shaped interior of the filter device 4. The electrode 45 is at least substantially made of a high quality spring steel or chromium steel and is supported by an electrode support 43/electrode holder 43 via a high voltage insulator, i.e., electrode insulation 46.

The (spray) electrode 45 hangs downward into the interior of the filter device 4 in a manner capable of oscillating. For example, the electrode 45 may oscillate back and forth transverse to the longitudinal axis of the electrode 45.

A cage 48 serves simultaneously as a counter electrode and a cleaning mechanism for the filter device 4. The cage 48 is connected to the ground or earth potential. The prevailing potential difference filters the exhaust gas flowing in the filter device 4, cf. arrows S6, as explained above. In the case of cleaning the filter device 4, the electrode 45 is de-energized. The cage 48 preferably has an octagonal regular cross-sectional profile, as can be seen, for example, in the view of FIG. 13. The cage 48 can preferably be laser cut during manufacture.

After leaving the heat exchanger 3, the flue gas flows through the turning chamber 34 into the inlet 44 of the filter device 4.

Here, the (optional) filter device 4 is optionally provided fully integrated in the boiler 11, whereby the wall surface facing the heat exchanger 3 and flushed by the heat exchange medium is also used for heat exchange from the direction of the filter device 4, thus further improving the efficiency of the system 1. Thus, at least a part of the wall the filter device 4 can be flushed with the heat exchange medium, whereby at least a part of this wall is cooled with boiler water.

At filter outlet 47, the cleaned exhaust gas flows out of filter device 4 as indicated by arrows S7. After exiting the filter, a portion of the exhaust gas is returned to the primary combustion zone 26 via the recirculation device 5. This will also be explained in more detail later. The remaining part of the exhaust gas is led out of the boiler 11 via the exhaust gas outlet 41.

An ash removal 7/ash discharge 7 is arranged in the lower part of the boiler 11. Via an ash discharge screw 71, the ash separated and falling out, for example, from the combustion chamber 24, the boiler tubes 32 and the filter device 4 is discharged laterally from the boiler 11.

The combustion chamber 24 and boiler 11 of this embodiment were calculated using CFD simulations. Further, field experiments were conducted to confirm the CFD simulations. The starting point for the considerations were calculations for a 100 kW (kilo watts) boiler, but a power range from 20 to 500 kW was taken into account.

A CFD simulation (CFD=Computational Fluid Dynamics) is the spatially and temporally resolved simulation of flow and heat conduction processes. The flow processes may be laminar and/or turbulent, may occur accompanied by chemical reactions, or may be a multiphase system. CFD simulations are thus well suited as a design and optimization tool. In the present invention, CFD simulations were used to optimize the fluidic parameters in such a way as to solve the above tasks of the invention. In particular, as a result, the mechanical design and dimensioning of the boiler 11, the combustion chamber 24, the secondary air nozzles 291 and the combustion chamber nozzle 203 were largely defined by the CFD simulation and also by associated practical experiments. The simulation results are based on a flow simulation with consideration of heat transfer. Examples of results from such CFD simulations are shown in FIGS. 20 and 21.

The above components of the biomass heating system 1 and boiler 11, which are results of the CFD simulations, are described in more detail below.

(Combustion Chamber)

The design of the combustion chamber shape is of importance in order to be able to comply with the task-specific requirements. The combustion chamber shape or geometry is intended to achieve the best possible turbulent mixing and homogenization of the flow over the cross-section of the flue gas duct, a minimization of the firing volume, as well as a reduction of the excess air and the recirculation ratio (efficiency, operating costs), a reduction of CO and CxHx emissions, NOx emissions, dust emissions, a reduction of local temperature peaks (fouling and slagging), and a reduction of local flue gas velocity peaks (material stress and erosion).

FIG. 4, which is a partial view of FIG. 2, and FIG. 5, which is a sectional view through boiler 11 along vertical section line A2, depict a combustion chamber geometry that meets the aforementioned requirements for biomass heating systems over a wide power range of, for example, 20 to 500 kW. Moreover, the vertical section line A2 can also be understood as the center or central axis of the oval combustion chamber 24.

The dimensions given in FIGS. 3 and 4 and determined via CFD calculations and practical experiments for an exemplary boiler with approx. 100 kW are in detail as follows:

BK1=172 mm+−40 mm, preferably +−17 mm;

BK2=300 mm+−50 mm, preferably +−30 mm;

BK3=430 mm+−80 mm, preferably +−40 mm;

BK4=538 mm+−80 mm, preferably +−50 mm;

BK5=(BK3−BK2)/2=e.g. 65 mm+−30 mm, preferably +−20 mm;

BK6=307 mm+−50 mm, preferably +−20 mm;

BK7=82 mm+−20 mm, preferably +−20 mm;

BK8=379 mm+−40 mm, preferably +−20 mm;

BK9=470 mm+−50 mm, preferably +−20 mm;

BK10=232 mm+−40 mm, preferably +−20 mm;

BK11=380 mm+−60 mm, preferably +−30 mm;

BK12=460 mm+−80 mm, preferably +−30 mm.

With these values, both the geometries of the primary combustion zone 26 and the secondary combustion zone 27 of the combustion chamber 24 are optimized in the present case. The specified size ranges are ranges with which the requirements are just as (approximately) fulfilled as with the specified exact values.

Preferably, a chamber geometry of the primary combustion zone 26 and the combustion chamber 24 (or an internal volume of the primary combustion zone 26 of the combustion chamber 24) can be defined based on the following basic parameters:

A volume having an oval horizontal base with dimensions of 380 mm+−60 mm (preferably +−30 mm)×320 mm+−60 mm (preferably +−30 mm), and a height of 538 mm+−80 mm (preferably +−50 mm).

The above size data can also be applied to boilers of other output classes (e.g. 50 kW or 200 kW) scaled in relation to each other.

As a further embodiment thereof, the volume defined above may include an upper opening in the form of a combustion chamber nozzle 203 provided in the secondary combustion zone 27 of the combustion chamber 24, which includes a combustion chamber slope 202 projecting into the secondary combustion zone 27, which preferably includes the heat exchange medium 38. The combustion chamber slope 202 reduces the cross-sectional area of the secondary combustion zone 27. Here, the combustion chamber slope 202 is provided by an angle k of at least 5%, preferably by an angle k of at least 15% and even more preferably by at least an angle k of 19% with respect to a fictitious horizontal or straight provided combustion chamber ceiling H (cf. the dashed horizontal line H in FIG. 4).

In addition, a combustion chamber ceiling 204 is also provided sloping upwardly in the direction of the inlet 33. Thus, the combustion chamber 24 in the secondary combustion zone 27 has the combustion chamber ceiling 204, which is provided inclined upward in the direction of the inlet 33 of the heat exchanger 3. This combustion chamber ceiling 204 extends at least substantially straight or straight and inclined in the section of FIG. 2. The angle of inclination of the straight or flat combustion chamber ceiling 204 relative to the (notional) horizontal can preferably be 4 to 15 degrees.

With the combustion chamber ceiling 204, another (ceiling) slope is provided in the combustion chamber 24 in front of the inlet 33, which together with the combustion chamber slope 202 forms a funnel. This funnel turns the upward swirl or vortex flow to the side and redirects this flow approximately to the horizontal. Due to the already turbulent upward flow and the funnel shape before the inlet 33, it is ensured that all heat exchanger tubes 32 or boiler tubes 32 are flowed through evenly, thus ensuring an evenly distributed flow of the flue gas in all boiler tubes 32. This optimizes the heat transfer in the heat exchanger 3 quite considerably.

In particular, the combination of the vertical and horizontal slopes 203, 204 in the secondary combustion zone in combination as the inlet geometry in the convective boiler can achieve a uniform distribution of the flue gas to the convective boiler tubes.

The combustion chamber slope 202 serves to homogenize the flow S3 in the direction of the heat exchanger 3 and thus the flow into the boiler tubes 32. This ensures that the flue gas is distributed as evenly as possible to the individual boiler tubes in order to optimize heat transfer there.

Specifically, the combination of the slopes with the inlet cross-section of the boiler rotates the flue gas flow in such a way that the flue gas flow or flow rate is distributed as evenly as possible to the respective boiler tubes 32.

In the prior art, there are often combustion chambers with rectangular or polygonal combustion chamber and nozzle, however, the irregular shape of the combustion chamber and nozzle and their interaction are another obstacle to uniform air distribution and good mixing of air and fuel and thus good burnout, as recognized presently. In particular, with an angular geometry of the combustion chamber, flow threads or preferential flows are created, which disadvantageously lead to an uneven flow in the heat exchanger tubes 32.

Therefore, in the present case, combustion chamber 24 is provided without dead corners or dead edges.

Thus, it was recognized that the geometry of the combustion chamber (and of the entire flow path in the boiler) plays a significant role in the considerations for optimizing the biomass heating system 1. Therefore, the basic oval or round geometry without dead corners described herein was chosen (in departure from the usual rectangular or polygonal or purely cylindrical shapes). In addition, this basic geometry of the combustion chamber and its design were also optimized with the dimensions/dimensional ranges given above. These dimensions/range of dimensions are selected in such a way that, in particular, different fuels (wood chips and pellets) with different quality (for example, with different water content) can be burned with very high efficiency. This is what the field tests and CFD simulations have shown.

In particular, the primary combustion zone 26 of the combustion chamber 24 may comprise a volume that preferably has an oval or approximately circular horizontal cross-section in its outer periphery (such a cross-section is exemplified by A1 in FIG. 2). This horizontal cross-section may further preferably represent the footprint of the primary combustion zone 26 of the combustion chamber 24. Over the height indicated by the double arrow BK4, the combustion chamber 24 may have an approximately constant cross-section. In this respect, the primary combustion zone 24 may have an approximately oval-cylindrical volume. Preferably, the side walls and the base surface (grate) of the primary combustion zone 26 may be perpendicular to each other. In this case, the slopes 203, 204 described above can be provided integrally as walls of the combustion chamber 24, with the slopes 203, 204 forming a funnel that opens into the inlet 33 of the heat exchanger 33, where it has the smallest cross-section.

The term “approximate” is used above because individual notches, deviations due to design or small asymmetries may of course be present, for example at the transitions of the individual combustion chamber bricks 29 to one another. However, these minor deviations play only a minor role in terms of flow.

The horizontal cross-section of the combustion chamber 24 and, in particular, of the primary combustion zone 26 of the combustion chamber 24 may likewise preferably be of regular design. Further, the horizontal cross-section of the combustion chamber 24 and in particular the primary combustion zone 26 of the combustion chamber 24 may preferably be a regular (and/or symmetrical) ellipse.

In addition, the horizontal cross-section (the outer perimeter) of the primary combustion zone 26 can be designed to be constant over a predetermined height, (for example 20 cm).

Thus, in the present case, an oval-cylindrical primary combustion zone 26 of the combustion chamber 24 is provided, which, according to CFD calculations, enables a much more uniform and better air distribution in the combustion chamber 24 than in rectangular combustion chambers of the prior art. The lack of dead spaces also avoids zones in the combustion chamber with poor air flow, which increases efficiency and reduces slag formation.

Similarly, nozzle 203 in combustion chamber 24 is configured as an oval or approximately circular constriction to further optimize flow conditions. The swirl of the flow in the primary combustion zone 26 explained above, which is caused by the specially designed secondary air nozzles 291 according to the invention, results in a roughly helical or spiral flow pattern directed upward, whereby an equally oval or approximately circular nozzle favors this flow pattern, and does not interfere with it as do conventional rectangular nozzles. This optimized nozzle 203 concentrates the flue gas-air mixture flowing upwards in a rotating manner and ensures better mixing, preservation of the vortex flows in the secondary combustion zone 27 and thus complete combustion. This also minimizes the required excess air. This improves the combustion process and increases efficiency.

Thus, in particular, the combination of the secondary air nozzles 291 explained above (and explained again below with reference to FIG. 19) and the vortex flows induced thereby with the optimized nozzle 203 serves to concentrate the upwardly rotating flue gas/air mixture. This provides at least near complete combustion in the secondary combustion zone 27.

Thus, a swirling flow through the nozzle 203 is focused and directed upward, extending this flow further upward than is common in the prior art. This is caused by the reduction of the swirling distance of the airflow to the rotation or swirl central axis forced by the nozzle 203 (cf. analogously the physics of the pirouette effect), as is evident to the skilled person from the laws of physics concerning angular momentum.

In addition, the flow pattern in the secondary combustion zone 27 and from the secondary combustion zone 27 to the boiler tubes 32 is optimized in the present case, as explained in more detail below.

According to CFD calculations, the combustion chamber slope 202 of FIG. 4, which can also be seen without reference signs in FIGS. 2 and 3 and at which the combustion chamber 25 (or its cross-section) tapers at least approximately linearly from the bottom to the top, ensures a uniformity of the flue gas flow in the direction of the heat exchanger 4, which can improve its efficiency. Here, the horizontal cross-sectional area of the combustion chamber 25 preferably tapers by at least 5% from the beginning to the end of the combustion chamber slope 202. In this case, the combustion chamber slope 202 is provided on the side of the combustion chamber 25 facing the heat exchange device 4, and is provided rounded at the point of maximum taper. In the state of the art, parallel or straight combustion chamber walls without a taper (so as not to obstruct the flow of flue gas) are common. In addition, individually or in combination, the combustion chamber ceiling 204, which extends obliquely upward to the horizontal in the direction of the inlet 33, deflects the vortex flows in the secondary combustion zone 27 laterally, thereby equalizing them in their flow velocity distribution.

The inflow or deflection of the flue gas flow upstream of the shell-and-tube heat exchanger is designed in such a way that an uneven inflow to the tubes is avoided as far as possible, which means that temperature peaks in individual boiler tubes 32 can be kept low and thus the heat transfer in the heat exchanger 4 can be improved (best possible utilization of the heat exchanger surfaces). As a result, the efficiency of the heat exchange device 4 is improved.

In detail, the gaseous volume flow of the flue gas is guided through the inclined combustion chamber wall 203 at a uniform velocity (even in the case of different combustion conditions) to the heat exchanger tubes or the boiler tubes 32. The sloped combustion chamber ceiling 204 further enhances this effect, creating a funnel effect. The result is a uniform heat distribution of the individual boiler tubes 32 heat exchanger surfaces concerned and thus an improved utilization of the heat exchanger surfaces. The exhaust gas temperature is thus lowered and the efficiency increased. The flow distribution, in particular at the indicator line WT1 shown in FIG. 3, is significantly more uniform than in the prior art. The line WT1 represents an inlet surface for the heat exchanger 3. The indicator line WT3 indicates an exemplary cross-sectional line through the filter device 4 in which the flow is set up as homogeneously as possible or is approximately equally distributed over the cross-section of the boiler tubes 32 (due, among other things, to flow baffles at the inlet to the filter device 4 and due to the geometry of the turning chamber 35). A uniform flow through the filter device 3 or the last boiler pass minimizes stranding and thereby also optimizes the separation efficiency of the filter device 4 and the heat transfer in the biomass heating system 1.

Further, an ignition device 201 is provided in the lower part of the combustion chamber 25 at the fuel bed 28. This can cause initial ignition or re-ignition of the fuel. It can be the ignition device 201 a glow igniter. The ignition device is advantageously stationary and horizontally offset to the side of the place where the fuel is introduced.

Furthermore, a lambda probe (not shown) can (optionally) be provided after the outlet of the flue gas (i.e., after S7) from the filter device. The lambda sensor enables a controller (not shown) to detect the respective heating value. The lambda sensor can thus ensure the ideal mixing ratio between the fuels and the oxygen supply. Despite different fuel qualities, high efficiency and higher efficiency are achieved as a result.

The fuel bed 28 shown in FIG. 5 shows a rough fuel distribution due to the fuel being fed from the right side of FIG. 5.

Further shown in FIGS. 4 and 5 is a combustion chamber nozzle 203 in which a secondary combustion zone 27 is provided and which accelerates and focuses the flue gas flow. As a result, the flue gas flow is better mixed and can burn more efficiently in the post-combustion zone 27 or secondary combustion zone 27. The area ratio of the combustion chamber nozzle 203 is in the range of 25% to 45%, but is preferably 30% to 40%, and is, for example for a 100 kW biomass heating system 1, ideally 36%+−1% (ratio of the measured input area to the measured output area of the nozzle 203).

Consequently, the foregoing details of the combustion chamber geometry of the primary combustion zone 26 together with the geometry of the secondary air nozzles 291 and the nozzle 203 constitute an advantageous further embodiment of the present disclosure.

(Combustion Chamber Bricks)

FIG. 6 shows a three-dimensional sectional view (from diagonally above) of the primary combustion zone 26 as well as the isolated part of the secondary combustion zone 27 of the combustion chamber 24 with the rotating grate 25, and in particular of the special design of the combustion chamber bricks 29. FIG. 7 shows an exploded view of the combustion chamber bricks 29 corresponding to FIG. 6. The views of FIGS. 6 and 7 can preferably be designed with the dimensions of FIGS. 4 and 5 listed above. However, this is not necessarily the case.

The chamber wall of the primary combustion zone 26 of the combustion chamber 24 is provided with a plurality of combustion chamber bricks 29 in a modular construction, which facilitates, among other things, fabrication and maintenance. Maintenance is facilitated in particular by the possibility of removing individual combustion chamber bricks 29.

Positive-locking grooves 261 and projections 262 (in FIG. 6, to avoid redundancy, only a few of these are designated in each of the figures by way of example) are provided on the bearing surfaces/support surfaces 260 of the combustion chamber bricks 29 to create a mechanical and largely airtight connection, again to prevent the ingress of disruptive foreign air. Preferably, two at least largely symmetrical combustion chamber bricks each (with the possible exception of the openings for the secondary air or the recirculated flue gas) form a complete ring. Further, three rings are preferably stacked on top of each other to form the oval-cylindrical or alternatively at least approximately circular (the latter is not shown) primary combustion zone 26 of the combustion chamber 24.

Three further combustion chamber bricks 29 are provided as the upper end, with the annular nozzle 203 being supported by two retaining bricks 264, which are positively fitted onto the upper ring 263. Grooves 261 are provided on all support surfaces 260 either for suitable projections 262 and/or for insertion of suitable sealing material.

The mounting blocks 264, which are preferably symmetrical, may preferably have an inwardly inclined slope 265 to facilitate sweeping of fly ash onto the rotating grate 25.

The lower ring 263 of the combustion chamber bricks 29 rests on a bottom plate 251 of the rotating grate 25. Ash is increasingly deposited on the inner edge between this lower ring 263 of the combustion chamber bricks 29, which thus advantageously seals this transition independently and advantageously during operation of the biomass heating system 1.

The openings for the recirculation nozzles 291 or secondary air nozzles 291 are provided in the central ring of the combustion chamber bricks 29. In this case, the secondary air nozzles 291 are provided at least approximately at the same (horizontal) height of the combustion chamber 24 in the combustion chamber bricks 29.

Presently, three rings of combustion chamber bricks 29 are provided as this is the most efficient way of manufacturing and also maintenance. Alternatively, 2, 4 or 5 such rings may be provided.

The combustion chamber bricks 29 are preferably made of high-temperature silicon carbide, which makes them highly wear-resistant.

The combustion chamber bricks 29 are provided as shaped bricks. The combustion chamber bricks 29 are shaped in such a way that the inner volume of the primary combustion zone 26 of the combustion chamber 24 has an oval horizontal cross-section, thus avoiding dead spots or dead spaces through which the flue gas-air mixture does not normally flow optimally, as a result of which the fuel present there is not optimally burned, by means of an ergonomic shape. Because of the present shape of the combustion chamber bricks 29, the flow of primary air through the grate 25, which also fits the distribution of the fuel over the grate 25, and the possibility of unobstructed vortex flows is improved; and consequently, the efficiency of the combustion is improved.

The oval horizontal cross-section of the primary combustion zone 26 of the combustion chamber 24 is preferably a point-symmetrical and/or regular oval with the smallest inner diameter BK3 and the largest inner diameter BK11. These dimensions were the result of optimizing the primary combustion zone 26 of the combustion chamber 24 using CFD simulation and practical tests.

(Rotating Grate)

FIG. 8 shows a top view of the rotating grate 25 as seen from section line A1 of FIG. 2.

The top view of FIG. 8 can preferably be designed with the dimensions listed above. However, this is not necessarily the case.

The rotating grate 25 has the bottom plate 251 as a base element. A transition element 255 is provided in a roughly oval-shaped opening of the bottom plate 251 to bridge a gap between a first rotating grate element 252, a second rotating grate element 253, and a third rotating grate element 254, which are rotatably supported. Thus, the rotating grate 25 is provided as a rotating grate with three individual elements, i.e., this can also be referred to as a 3-fold rotating grate. Air holes are provided in the rotating grate elements 252, 253 and 254 for primary air to flow through.

The rotating grate elements 252, 253 and 254 are flat and heat-resistant metal plates, for example made of a metal casting, which have an at least largely flat configured surface on their upper side and are connected on their underside to the bearing axles 81, for example via intermediate support elements. When viewed from above, the rotating grate elements 252, 253, and 254 have curved and complementary sides or outlines.

In particular, the rotating grate elements 252, 253, 254 may have mutually complementary and curved sides, preferably the second rotating grate element 253 having respective sides concave to the adjacent first and third rotating grate elements 252, 254, and preferably the first and third rotating grate elements 252, 254 having respective sides convex to the second rotating grate element 253. This improves the crushing function of the rotary grating elements, since the length of the fracture is increased and the forces acting for crushing (similar to scissors) act in a more targeted manner.

The rotating grate elements 252, 253 and 254 (as well as their enclosure in the form of the transition element 255) have an approximately oval outer shape when viewed together in plan view, which again avoids dead corners or dead spaces here in which less than optimal combustion could take place or ash could accumulate undesirably. The optimum dimensions of this outer shape of the rotating grate elements 252, 253 and 254 are indicated by the double arrows DR1 and DR2 in FIG. 8. Preferably, but not exclusively, DR1 and DR2 are defined as follows:

DR1=288 mm+−40 mm, preferably +−20 mm

DR2=350 mm+−60 mm, preferably +−20 mm

These values turned out to be the optimum values (ranges) during the CFD simulations and the following practical test. These dimensions correspond to those of FIGS. 4 and 5. These dimensions are particularly advantageous for the combustion of different fuels or the fuel types wood chips and pellets (hybrid firing) in a power range from 20 to 200 kW.

In this case, the rotating grate 25 has an oval combustion area, which is more favorable for fuel distribution, fuel air flow, and fuel burnup than a conventional rectangular combustion area. The combustion area 258 is formed in the core by the surfaces of the rotating grate elements 252, 253 and 254 (in the horizontal state). Thus, the combustion area is the upward facing surface of the rotating grate elements 252, 253, and 254. This oval combustion area advantageously corresponds to the fuel support surface when this is applied or pushed onto the side of the rotating grate 25 (cf. the arrow E of FIGS. 9, 10 and 11). In particular, fuel may be supplied from a direction parallel to a longer central axis (major axis) of the oval combustion area of the rotating grate 25.

The first rotating grate element 252 and the third rotating grate element 254 may preferably be identical in their combustion areas 258. Further, the first rotating grate element 252 and the third rotating grate element 254 may be identical or identical in construction to each other. This can be seen, for example, in FIG. 9, where the first rotating grate element 252 and the third rotating grate element 254 have the same shape.

Further, the second rotating grate element 253 is disposed between the first rotating grate element 252 and the third rotating grate element 254.

Preferably, the rotating grate 25 is provided with an approximately point-symmetrical oval combustion area 258.

Similarly, the rotating grate 25 may form an approximately elliptical combustion area 258, where DR2 is the dimensions of its major axis and DR1 is the dimensions of its minor axis.

Further, the rotating grate 25 may have an approximately oval combustion area 258 that is axisymmetric with respect to a central axis of the combustion area 258.

Further, the rotating grate 25 may have an approximately circular combustion area 258, although this entails minor disadvantages in fuel feed and distribution.

Further, two motors or drives 231 of the rotating mechanism 23 are provided to rotate the rotating grate elements 252, 253 and 254 accordingly. More details of the particular function and advantages of the present rotating grate 25 will be described later with reference to FIGS. 9, 10 and 11.

Particularly in pellet and wood chip heating systems (and especially in hybrid biomass heating systems), failures can increasingly occur due to slag formation in the combustion chamber 24, especially on the rotating grate 25. Slag is formed during a combustion process whenever temperatures above the ash melting point are reached in the embers. The ash then softens, sticks together, and after cooling forms solid, and often dark-colored, slag. This process, also known as sintering, is undesirable in the biomass heating system 1 because the accumulation of slag in the combustion chamber 24 can cause it to malfunction: it shuts down. The combustion chamber 24 must usually be opened and the slag must be removed.

The ash melting range (this extends from the sintering point to the yield point) depends quite significantly on the fuel material used. Spruce wood, for example, has a critical temperature of about 1,200° C. But the ash melting range of a fuel can also be subject to strong fluctuations. Depending on the amount and composition of the minerals contained in the wood, the behavior of the ash in the combustion process changes.

Another factor that can influence the formation of slag is the transport and storage of the wood pellets or chips. These should namely enter the combustion chamber 24 as undamaged as possible. If the wood pellets are already crumbled when they enter the combustion process, this increases the density of the glow bed. Greater slag formation is the result. In particular, the transport from the storage room to the combustion chamber 24 is of importance here. Particularly long paths, as well as bends and angles, lead to damage or abrasion of the wood pellets.

Another factor concerns the management of the combustion process. Until now, the aim has been to keep temperatures rather high in order to achieve the best possible burnout and low emissions. By optimizing the combustion chamber geometry and the geometry of the combustion zone 258 of the rotating grate 25, it is possible to keep the combustion temperature lower at the grate and high in the area of the secondary air nozzles 291, thus reducing slag formation at the grate.

In addition, resulting slag (and also ash) can be advantageously removed due to the particular shape and functionality of the present rotating grate 25. This will now be explained in more detail with reference to FIGS. 9, 10 and 11.

FIGS. 9, 10, and 11 show a three-dimensional view of the rotating grate 25 including the bottom plate 251, the first rotating grate element 252, the second rotating grate element 253, and the third rotating grate element 254. The views of FIGS. 9, 10 and 11 can preferably correspond to the dimensions given above. However, this is not necessarily the case.

This view shows the rotating grate 25 as an exposed slide-in component with rotating grate mechanism 23 and drive(s) 231. The rotating grate 25 is mechanically provided in such a way that it can be individually prefabricated in the manner of a modular system, and can be inserted and installed as a slide-in part in a provided elongated opening of the boiler 11. This also facilitates the maintenance of this wear-prone part. In this way, the rotating grate 25 can preferably be of modular design, whereby it can be quickly and efficiently removed and reinserted as a complete part with rotating grate mechanism 23 and drive 231. The modularized rotating grate 25 can thus also be assembled and disassembled by means of quick-release fasteners. In contrast, state of the art rotating grates are regularly mounted fixedly, and thus are difficult to maintain or install.

The drive 231 may include two separately controllable electric motors. These are preferably provided on the side of the rotating grate mechanism 23. The electric motors can have reduction gears. Further, end stop switches may be provided to provide end stops respectively for the end positions of the rotating grate elements 252, 253 and 254.

The individual components of the rotating grate mechanism 23 are designed to be interchangeable. For example, the gears are designed to be attachable. This facilitates maintenance and also a side change of the mechanics during assembly, if necessary.

The aforementioned openings 256 are provided in the rotating grate elements 252, 253 and 254 of the rotating grate 25. The rotary grating elements 252, 253 and 254 can be rotated about the respective bearing or rotation axis 81 by at least 90 degrees, preferably by at least 120 degrees, even more preferably by 170 degrees, via their respective bearing axes 81, which are driven via the rotary mechanism 23 by the drive 231, presently the two motors 231. Here, the maximum angle of rotation may be 180 degrees, or slightly less than 180 degrees, as permitted by the grate lips 257. In this regard, the rotating mechanism 23 is arranged such that the third rotating grate element 254 can be rotated individually and independently of the first rotating grate element 252 and the second rotating grate element 243, and such that the first rotating grate element 252 and the second rotating grate element 243 can be rotated together and independently of the third rotating grate element 254. The rotating mechanism 23 may be provided accordingly, for example, by means of impellers, toothed or drive belts, and/or gears.

The rotating grate elements 252, 253 and 254 can preferably be manufactured as a cast grate with a laser cut to ensure accurate shape retention. This is particularly in order to define the airflow through the fuel bed 28 as precisely as possible, and to avoid disturbing airflows, for example air strands at the edges of the rotating grate elements 252, 253 and 254.

The openings 256 in the rotating grate elements 252, 253, and 254 are arranged to be small enough for the usual pellet material and/or wood chips not to fall through, and large enough for the fuel to flow well with air. In addition, the openings 256 are large enough to be blocked by ash particles or impurities (e.g., no stones in the fuel).

FIG. 9 now shows the rotating grate 25 in closed position, with all rotating grate elements 252, 253 and 254 horizontally aligned or closed. This is the position in control mode. The uniform arrangement of the plurality of openings 256 ensures a uniform flow of fuel through the fuel bed 28 (which is not shown in FIG. 9) on the rotating grate 25. In this respect, the optimum combustion condition can be produced here. The fuel is applied to the rotating grate 25 from the direction of arrow E; in this respect, the fuel is pushed up onto the rotating grate 25 from the right side of FIG. 9.

During operation, ash and or slag accumulates on the rotating grate 25 and in particular on the rotating grate elements 252, 253 and 254. The present rotating grate 25 can be used to efficiently clean the rotating grate 25.

FIG. 10 shows the rotating grate in the state of a partial cleaning of the rotating grate 25 in the ember maintenance mode. For this purpose, only the third rotating grate element 254 is rotated. By rotating only one of the three rotating grate elements, the embers are maintained on the first and second rotating grate elements 252, 253, while at the same time the ash and slag are allowed to fall downwardly out of the combustion chamber 24. As a result, no external ignition is required to resume operation (this saves up to 90% ignition energy). Another consequence is a reduction in wear of the ignition device (for example, of an ignition rod) and a saving in electricity. Further, ash cleaning can advantageously be performed during operation of the biomass heating system 1.

FIG. 10 also shows a condition of annealing during (often already sufficient) partial cleaning. Thus, the operation of the system 1 can advantageously be more continuous, which means that, in contrast to the usual full cleaning of a conventional grate, there is no need for a lengthy full ignition, which can take several tens of minutes.

In addition, potential slag formation or accumulation at the two outer edges of the third rotating grate element 254 is (broken up) during rotation thereof, wherein, due to the curved outer edges of the third rotating grate element 254, shearing not only occurs over a greater overall length than in conventional rectangular elements of the prior art, but also occurs with an uneven distribution of movement with respect to the outer edge (greater movement occurs at the center than at the lower and upper edges). Thus, the crushing function of the rotating grate 25 is significantly enhanced.

In FIG. 10, grate lips 257 (on both sides) of the second rotating grate element 253 are visible. These grate lips 257 are arranged in such a way that the first rotating grate element 252 and the third rotating grate element 254 rest on the upper side of the grate lips 257 in the closed state thereof, and thus the rotating grate elements 252, 253 and 254 are provided without a gap to one another and are thus provided in a sealing manner. This prevents air strands and unwanted uneven primary air flows through the glow bed. Advantageously, this improves the efficiency of combustion.

FIG. 11 shows the rotating grate 25 in the state of universal cleaning, which is preferably carried out during a system shutdown. In this case, all three rotating grate elements 252, 253 and 254 are rotated, with the first and second rotating grate elements 252, 253 preferably being rotated in the opposite direction to the third rotating grate element 254. On the one hand, this realizes a complete emptying of the rotating grate 25, and on the other hand, the ash and slag is now broken up at four odd outer edges. In other words, an advantageous 4-fold crushing function is realized. What has been explained above with regard to FIG. 9 concerning the geometry of the outer edges also applies with regard to FIG. 10.

In summary, the present rotating grate 25 advantageously realizes two different types of cleaning (cf. FIGS. 10 and 11) in addition to normal operation (cf. FIG. 9), with partial cleaning allowing cleaning during operation of the system 1.

In comparison, commercially available rotating grate systems are not ergonomic and, due to their rectangular geometry, have disadvantageous dead corners in which the primary air cannot optimally flow through the fuel, which can result in air strand formation. Slagging also occurs at these corners. These points provide poorer combustion with poorer efficiency.

The present simple mechanical design of the rotating grate 25 makes it robust, reliable and durable.

(Heat Exchanger)

To optimize the heat exchanger 3, CFD simulations and field tests were again performed, in synergy with the combustion chamber geometries described above. It was also checked to what extent a spring turbulator or a band turbulator or a combination of both could improve the efficiency of the heat exchange process without, however, causing the pressure loss in the heat exchanger 3 to become too great. Turbulators increase the formation of turbulence in the boiler tubes 32, thereby reducing the flow velocity, increasing the residence time of the flue gas in the boiler tube 32, and thus increasing the efficiency of heat exchange. Specifically, the boundary layer of the flow is broken up at the pipe wall, improving heat transfer. However, the more turbulent the flow, the greater the pressure drop.

In addition, light soiling (so-called fouling with a thickness of 1 mm) was taken into account for all surfaces in contact with flue gas. The emissivity of such a fouling layer was assumed to be 0.6.

The result of this optimization is shown in FIG. 12, which is a detail cutaway view of FIG. 2.

The heat exchanger 3 has a vertically arranged bundle of boiler tubes 32, preferably each boiler tube 32 having both a spring and a band or spiral turbulator. The respective spring turbulator 36 preferably extends along the entire length of the respective boiler tube 32 and is spring-shaped. The respective band turbulator 37 preferably extends over approximately half the length of the respective boiler tube 32 and has a belt with a material thickness of 1.5 mm to 3 mm extending spirally in the axial direction of the boiler tube 32. Further, the respective band turbulator 37 may also be about 35% to 65% of the length of the respective boiler tube 32. The respective band turbulator 37 is preferably arranged with one end at the downstream end of the respective boiler tube 32. The combination of spring and belt or spiral turbulator can also be called double turbulator. Both belt and spiral turbulators are shown in FIG. 12. In the present dual turbulator, the band turbulator 37 is located within the spring turbulator 36.

Band turbulators 37 are provided because the band turbulator 37 increases the turbulence effect in the boiler tube 32 and produces a more homogeneous temperature and velocity profile when viewed across the cross-section of the tube, whereas without a band turbulator the tube would preferentially form a hot streak with higher velocities in the center of the tube that would continue to the exit of the boiler tube 32, which would adversely affect the efficiency of heat transfer. Thus, the band turbulators 37 at the bottom of the boiler tubes 32 improve convective heat transfer.

As an optimum preferred example, 22 boiler tubes with a diameter of 76.1 mm and a wall thickness of 3.6 mm can be used.

The pressure drop in this case can be less than 25 Pa. In this case, the spring turbulator 36 ideally has an outer diameter of 65 mm, a pitch of 50 mm, and a profile of 10×3 mm. In this case, the band turbulator 37 may have an outer diameter of 43 mm, a pitch of 150 mm, and a profile of 43×2 mm. A sheet thickness of the band turbulator can be 2 mm.

Good efficiency is achieved by means of 18 to 24 boiler tubes and a diameter of 70 to 85 mm with a wall thickness of 3 to 4.5 mm. Appropriately adapted spring and band turbulators can be used.

However, to achieve sufficient efficiency, between 14 and 28 boiler tubes 32 with a diameter between 60 and 80 mm with a wall thickness of 2 to 5 mm can be used. The pressure drop in these cases can be between 20 and 40 Pa, and can therefore be considered positive. The outer diameter, pitch and profile of the spring and band turbulators 36, 37 are provided to suit.

The desired target temperature at the outlet of the boiler tubes 32 may preferably be between 100 and 160 degrees Celsius at rated power.

(Cleaning Device for the Boiler)

FIG. 13 shows a cleaning device 9 with which both the heat exchanger 3 and the filter device 4 can be automatically (ab-) cleaned. FIG. 13 depicts the cleaning device from the boiler 11 highlighted for illustrative purposes. The cleaning device 9 concerns the entire boiler 11 and thus concerns the convective part of the boiler 11 and also the last boiler pass, in which the electrostatic filter device 4 can optionally be integrated.

The cleaning device 9 has two cleaning drives 91, preferably electric motors, which rotatably drive two cleaning shafts 92, which in turn are mounted in a shaft holder 93. Preferably, the cleaning shafts 92 may also be similarly rotatably mounted at other locations, such as at the distal ends. The cleaning shafts 92 have projections 94 to which the cage 48 of the filter device 4 and turbulator holders/brackets 95 are connected via joints or via pivot bearings.

The turbulator mount 95 is highlighted and shown enlarged in FIG. 14. The turbulator holder 95 has a comb-like configuration and is preferably horizontally symmetrical. Further, the turbulator holder 95 is formed as a flat metal piece with a material thickness in thickness direction D between 2 and 5 mm. The turbulator holder 95 has two pivot bearing receptacles 951 on its underside for connection to pivot bearing journals (not shown) of the projections 94 of the cleaning shafts 92. The pivot bearing receptacles 951 have a horizontal clearance in which pivot bearing journals or a pivot bearing linkage 955 can/may move back and forth. Vertically projecting projections 952 include a plurality of recesses 954 in and with which dual turbulators 36, 37 can be secured. The recesses 954 may be spaced apart by a distance equal to the gear spacing of the twin turbulators 36, 37. In addition, passages 953 for the flue gas may preferably be arranged in the turbulator support 95 to optimize the flow from the boiler tubes 32 into the filter device 4. Otherwise, the flat metal would stand at right angles to the flow and obstruct it too much.

In addition, when the respective spring turbulator 36 including the spiral turbulator (double turbulator) is mounted, the spiral automatically rotates by its own weight into the receptacle of the turbulator holder 95 (which can also be referred to as a receiving rod) and is thus fixed and secured. This significantly facilitates the assembly.

FIGS. 15 and 16 show the cleaning mechanism 9 without the cage 48 in two different states. In this case, the cage bracket 481 can be seen more clearly.

FIG. 15 shows the cleaning mechanism 9 in a first state, with both the turbulator mounts 95 and the cage mount 481 in a down position. Attached to one of the cleaning shafts 92 is a two-armed impact/stop lever 96 with an impact/stop head 97. Alternatively, the striker 96 may be provided with one or more arms. The impact lever 96 with the stop head 97 is set up in such a way that it can be moved to the end of the (spray) electrode 45 or can strike against it.

FIG. 16 shows the cleaning mechanism 9 in a second state, with both the turbulator mounts 95 and the cage mount 481 in an up position.

During the transition from the first state to the second state (and vice versa), rotation of the cleaning shafts 92 by means of the cleaning drives 91 vertically raises both the turbulator mount 95 and the cage mount 481 via the projections 952 (and a pivot linkage 955). This allows the twin turbulators 36, 37 in the boiler tubes 32 and also the cage 48 in the chimney of the filter device 4 to be moved up and down and can clean fly ash or the like from the respective walls accordingly.

Moreover, the striker 96 with the stop head 97 may strike the end of the (spray) electrode 45 during the transition from the first state to the second state. This striking at the free (i.e. not suspended) end of the (spray) electrode 45 has the advantage over conventional vibrating mechanisms (in which the electrode is moved by its suspension) that the (spray) electrode 45 can vibrate (ideally freely) according to its vibration characteristics after excitation by the striking itself. Here, the type of stop determines the oscillations or oscillation modes of the (spray) electrode 45. It is possible to strike the (spray) electrode 45 from below (i.e., from its longitudinal axis direction or from its longitudinal direction) for the excitation of a shock wave or a longitudinal oscillation. However, the (spray) electrode 45 can also be struck laterally (in FIGS. 15 and 16, for example, from the direction of arrow V), causing it to oscillate transversely. Alternatively, the (spray) electrode 45 (as shown in FIGS. 15 and 16) can be struck from below at its end from a slightly laterally offset direction. In the latter case, a plurality of different types of vibration are generated in the (spray) electrode 45 (by the impact), which add up advantageously in the cleaning effect and improve the cleaning efficiency. In particular, the shear effect of the transverse vibration on the surface of the (spray) electrode 45 can improve the cleaning effect.

In this respect, a shock or shock wave can occur in the elastic spring electrode 45 in the longitudinal direction of the electrode 45, which is preferably designed as an elongated plate-shaped rod. Likewise, transverse vibration of the (spray) electrode 45 may occur due to the acting transverse forces (which are oriented transversely or at right angles to the longitudinal axis direction of the electrode 45).

Likewise, you can create several types of vibration at the same time. In particular, a shock wave and/or longitudinal wave combined with a transverse vibration of the electrode 45 can again lead to improved cleaning of the electrode 45.

As a result, fully automatic cleaning can be implemented during ash removal into a common ash box at the front of the heating system (not shown) via discharge screw 71. Likewise, the spring steel electrode 48 can be cleaned without wear and with low noise.

Further, the cleaning device 9 is simple and inexpensive to manufacture in the manner described and has a simple and low-wear structure.

Furthermore, the cleaning device 9 with the drive mechanism is set up in such a way that ash residues can advantageously be cleaned off from the first draught of the boiler tubes 32 by the turbulators and can drop downwards.

In addition, the cleaning device 9 is installed in the lower, so-called “cold area” of the boiler 11, which also reduces wear, since the mechanics are not exposed to very high temperatures (i.e. the thermal load is reduced). In contrast, in the state of the art, the cleaning mechanism is installed in the upper area of the system, which increases wear to a correspondingly disadvantageous extent.

Regular automated cleaning also improves the efficiency of the system 1, as the surfaces of the heat exchanger 3 are cleaner. Likewise, the filter device 4 can work more efficiently because its surfaces are also cleaner. This is also important because the electrodes of the filter device 4 get dirty faster than the convective part of the boiler 11.

In this case, cleaning of the electrodes of the filter device 4 is advantageously also possible during operation or during the operation of the boiler 11.

(Modularization of System and Boiler Components)

Preferably, the biomass heating system 1 is designed in such a way that the complete drive mechanism in the lower boiler area (including rotating grate mechanism including rotating grate, heat exchanger cleaning mechanism, drive mechanism for moving floor, mechanism for filter device, cleaning basket and drive shafts and ash discharge screw) can be quickly and efficiently removed and reinserted using the “drawer principle”. An example of this is illustrated above with the rotating grate 25 with reference to FIGS. 9 to 11. This facilitates maintenance work.

(Glow Bed Height Measurement)

FIG. 17 shows a glow bed height sensing mechanism 86 (shown in relief) with a fuel level flap 83. FIG. 18 shows a detailed view of the fuel level flap 83 of FIG. 17.

In detail, the glow bed height measurement mechanism 86 includes a rotation axis 82 for the fuel level flap 83. The rotary axis 82 has a central axis 832 and has a bearing notch 84 on one side for holding the rotary axis 82, as well as a sensor flange 85 for mounting an angular or rotary sensor (not shown).

The rotation axis 82 is preferably provided with a hexagonal profile. The mounting of the fuel level flap 83 may be provided such that it comprises two openings 834 with an internal hexagon. This allows the fuel level flap 83 to be simply pushed onto the rotary shaft 82 and fixed in place. Further, the fuel level flap 83 may be a simple sheet metal molding.

The glow bed height measuring mechanism 86 is provided in the combustion chamber 24, preferably slightly offset from the center, above the fuel bed 28 or combustion area 258, that the fuel level flap 83 is raised in response to the fuel, if any, depending on the height of the fuel or fuel bed 28, thereby rotating the axis of rotation 82 in response to the height of the fuel bed 28. This rotation or also the absolute angle of the rotation axis 82 can/can be detected by a (not shown) non-contact rotation and/or angle sensor. Thus, an efficient and robust glow bed height measurement can be carried out.

The fuel level flap 83 is set up in such a way that it is beveled with respect to the central axis 823 of the rotation axis 82. In detail, a surface parallel 835 of a major surface 831 of the fuel level flap 83 may be arranged such that it is provided angularly with respect to the central axis 823 of the rotation axis 82. This angle can preferably be between 10 and 45 degrees. For angular measurement, note that the surface parallel 835 and the central axis 823 are thought to intersect (projected horizontally) at the central axis 823 to form an angle. Further, the surface parallel 835 is typically not aligned parallel to the leading edge of the fuel level flap 83.

Now, fuel feed 6 into combustion chamber 24 does not cause a flat fuel distribution, but rather raises an elongated hill. Consequently, with a beveled fuel level flap 83 and a parallel orientation of the central axis 823 of the axis of rotation 82 to the surface of the rotating grate 25, the rather oblique distribution of the fuel is accommodated in such a way that the main surface/area 831 of the fuel level flap 83 can lie flat on the fuel mound or fuel bed 28. This more planar support of the fuel level flap 83 reduces measurement errors due to irregularities in the fuel bed 28, and improves measurement accuracy and ergonomics.

In addition, by means of the geometry of the fuel level flap 83 shown above, the exact glow bed height can also be determined by means of a contactless rotation and/or angle sensor, despite different or varying fuel (wood chips, pellets). The ergonomically inclined shape adapts ideally to the fuel, which is also introduced rather obliquely by the stoker screw, and ensures representative measured values.

By means of the glow bed height measurement, the fuel height (and quantity) remaining on the combustion area 258 of the rotating grate 25 can be further accurately determined, thereby allowing the fuel supply and flow through the fuel bed 28 to be controlled such that the combustion process can be optimized.

In addition, the manufacture and assembly of this sensor is simple and inexpensive.

(Fluidic Design of the Biomass Heating System 1)

FIG. 19 shows a horizontal cross-sectional view through the combustion chamber at the level of the secondary air nozzles 291 and along the horizontal section line A6 of FIG. 5.

The dimensions given in FIG. 19 are merely to be understood as examples, and serve only to clarify the technical teachings of FIG. 3, among others.

For example, a length of a secondary air nozzle 291 may be between 40 and 60 mm. For example, a (maximum) diameter of the cylindrical or frustoconical secondary air nozzle 291 may be between 20 and 25 mm.

The angle shown relates to the two secondary air nozzles 291 closest to the longer main axis of the oval. The angle, exemplified as 26.1 degrees, is measured between the central axis of the secondary air nozzle 291 and the longer of the major axes of the oval of the combustion chamber 24. The angle can preferably be in the range of 15 degrees to 35 degrees. The remaining secondary air nozzles 291 may be further provided with an angle of their central axis functionally corresponding to that of the two secondary air nozzles 291 closest to the longer major axis of the oval for effecting the vortex flow (for example, with respect to the combustion chamber wall 24).

Shown in FIG. 19 are 10 secondary air nozzles 291, which are arranged such that their central axis or orientation, shown with the respective dashed (center) lines, is provided off-center with respect to the (symmetry) center of the oval of the combustion chamber geometry. In other words, the secondary air nozzles 291 do not aim at the center of the oval combustion chamber 24, but rather past its center or central axis (labeled A2 in FIG. 4). Accordingly, the central axis A2 can also be understood as the axis of symmetry regarding the oval combustion chamber geometry 24.

The secondary air nozzles 291 are oriented in such a way that they introduce the secondary air—viewed in the horizontal plane—tangentially into the combustion chamber 24. In other words, the secondary air nozzles 291 are each provided as an inlet for secondary air not directed toward the center of the combustion chamber. Incidentally, such a tangential inlet can also be used with a circular combustion chamber geometry.

There are all secondary air nozzles 291 oriented such that they each provide either a clockwise flow or a counterclockwise flow. In this respect, each secondary air nozzle 291 may contribute to the creation of the vortex flows, with each secondary air nozzle 291 having a similar orientation. With respect to the foregoing, it should be noted that in exceptional cases individual secondary air nozzles 291 may also be arranged in a neutral orientation (with orientation toward the center) or in an opposite orientation (with opposite orientation), although this may worsen the fluidic efficiency of the arrangement.

FIG. 20 shows three horizontal cross-sectional views for different boiler dimensions (50 kW, 100 kW and 200 kW) through the combustion chamber 24 of FIGS. 2 and 4 at the level of the secondary air nozzles 291, with details of the flow distributions in this cross-section at the respective nominal load case.

Equal shades of gray in FIG. 20 roughly indicate areas of equal flow velocity. In general, it is apparent from FIG. 20 that the secondary air nozzles 291 effect nozzle flows tangentially or off-center into the combustion chamber 24.

For clarification, the relevant flow velocities of these nozzle flows are explicitly given as examples in FIG. 20. It can be seen that the resulting nozzle flows extend relatively far into the combustion chamber 24, which can be used to cause strong vortex flows that cover a large portion of the volume of the combustion chamber 24.

The arrow in the combustion chamber 24 of the CFD calculation for a 200 kW boiler dimensioning indicates the swirl or vortex direction of the vortex flows induced by the secondary air nozzles 291. This also applies analogously to the other two boiler dimensions (50 kW, 100 kW) in FIG. 20. As an example, a right-turning vortex flow (viewed from above) is given.

Secondary air (preferably simply ambient air) is introduced into combustion chamber 24 via secondary air nozzles 291. In this process, the secondary air in the secondary air nozzles is accelerated to more than 10 m/s in the nozzle in the nominal load case. Compared to the prior art secondary air openings, the penetration depth of the resulting air jets in the combustion chamber 24 is increased, making it sufficient to induce an effective vortex flow extending over most of the combustion chamber volume.

With an oval (or even circular) cross-section of a combustion chamber 24, a tangential entry of air into the combustion chamber 24 creates a relatively undisturbed vortex flow, which may also be referred to as a swirl flow or a vortex sink flow. Here, vortex/spiral flows are formed. These spiral flows propagate upward in the combustion chamber 24 in a helical or spiral pattern.

FIG. 21 shows three vertical cross-sectional views for different boiler dimensions (50 kW, 100 kW, and 200 kW) through the biomass heating system along section line SL1 of FIG. 1, with details of the tangential entry of secondary nozzle flows into this cross-section.

Also in FIG. 21, equal shades of gray roughly indicate areas of equal flow velocity. In general, it can be seen from FIG. 21 that candle flame-shaped rotational flows S2 (cf. also FIG. 3) are present in the secondary combustion zone 27, which can advantageously extend to the combustion chamber ceiling 204. In addition, it can be seen that the flow through the boiler tubes 32 is quite uniform at about 1-2 m/s due to the previously explained funnel in the direction of the inlet 33. Regarding the advantages and the technical background of the above, please refer to the explanations on FIGS. 1 to 4.

### Other Embodiments

The invention admits other design principles in addition to the embodiments and aspects explained. Thus, individual features of the various embodiments and aspects can also be combined with each other as desired, as long as this is apparent to the person skilled in the art as being executable.

Further, instead of only three rotating grate elements 252, 253 and 254, two, four or more rotating grate elements may be provided. For example, with five rotating grate elements, these could be arranged with the same symmetry and functionality as with the three rotating grate elements presented. In addition, the rotating grate elements can also be shaped or formed differently from one another. More rotating grate elements have the advantage of increasing the crushing function.

It should be noted that other dimensions or combinations of dimensions can also be provided.

Instead of convex sides of the rotating grate elements 252 and 254, concave sides thereof may also be provided, and the sides of the rotating grate element 253 may have a complementary convex shape in sequence. This is functionally approximately equivalent.

Although 10 (ten) secondary air nozzles 291 are indicated in FIG. 19, a different number of secondary air nozzles 291 may be provided (depending on the dimensions of the biomass heating system).

The rotational flow or vortex flow in the combustion chamber 24 may be provided in a clockwise or counterclockwise direction.

The combustion chamber ceiling 204 may also be provided to slope in sections, such as in a stepped manner.

The secondary air nozzles 291 are not limited to purely cylindrical holes in the combustion chamber bricks 291. These can also be in the form of frustoconical openings or waisted openings.

The secondary (re)circulation can also only be supplied with secondary air or fresh air, and in this respect does not recirculate the flue gas, but merely supplies fresh air.

The dimensions and numbers given in relation to the exemplary embodiments are to be understood as merely exemplary. This technical teaching disclosed herein is not limited to these dimensions and may be modified, for example, if the dimensions of the boiler 11 (kW) are changed.

Fuels other than wood chips or pellets can be used as fuels for the biomass heating system.

The biomass heating system disclosed herein can also be fired exclusively with one type of a fuel, for example, only with pellets.

The embodiments disclosed herein have been provided for the purpose of describing and understanding the technical matters disclosed and are not intended to limit the scope of the present disclosure. Therefore, this should be construed to mean that the scope of the present disclosure includes any modification or other various embodiments based on the technical spirit of the present disclosure.

### LIST OF REFERENCE NUMERALS

1 Biomass heating system
11 Boiler
12 Boiler foot
13 Boiler housing
14 Water circulation device
2 combustion device
21 first maintenance opening for combustion device
22 Rotary mechanism holder
23 Rotating mechanism
24 Combustion chamber
25 Rotating grate
26 Primary combustion zone of the combustion chamber
27 Secondary combustion zone or radiation part of the combustion chamber
28 Fuel bed
29 Combustion chamber bricks
A1 first horizontal section line
A2 first vertical section line and vertical central axis of oval combustion chamber 24
201 Ignition device
202 Combustion chamber slope
203 Combustion chamber nozzle
204 Combustion chamber ceiling
231 Drive or motor(s) of the rotating mechanism
251 Bottom plate or Base plate of the rotating grate
252 First rotating grate element
253 Second rotating grate element
254 Third rotating grate element
255 Transition element
256 Openings
257 Rust lips
258 Combustion area
260 Support surfaces of the combustion chamber bricks
261 Groove
262 Lead
263 Ring
264 Retaining stones
265 Slope of the mounting blocks
3 Heat exchanger
31 Maintenance opening for heat exchanger
32 Boiler tubes
33 Boiler tube inlet
34 Turning chamber entry/inlet
35 Turning chamber
36 Spring turbulator
37 Belt or spiral turbulator
38 Heat exchange medium
4 Filter device
41 Exhaust gas outlet
42 Electrode supply line
43 Electrode holder
44 Filter inlet
45 Electrode
46 Electrode insulation
47 Filter outlet
48 Cage
5 Recirculation device
51, 54 Recirculation channel (s)
52 Flaps
53 Recirculation inlet
6 Fuel supply
61 Rotary valve
62 Fuel supply axis
63 Translation mechanics/mechanism
64 Fuel supply duct
65 Fuel supply opening
66 Drive motor
67 Fuel screw conveyor
7 Ash removal
71 Ash discharge screw conveyor
72 Ash removal motor with mechanics
81 Bearing axles
82 Rotation axis
83 Fuel level flap
831 Main area
832 Central axis
835 Surface parallel
84 Bearing notch/Support notch
85 Sensor flange
86 Glow bed height measuring mechanism
9 Cleaning device
91 Cleaning drive
92 Cleaning waves
93 Shaft holder
94 Projection
95 Turbulator holders
951 Pivot bearing mounting
952 Projections
953 Culverts
954 Recesses
955 Pivot bearing linkage
96 two-arm hammer
97 Stop head
211 Insulation material, for example vermiculite
291 Secondary air or recirculation nozzles
E Direction of fuel insertion
331 Insulation at boiler tube inlet
481 Cage mount

1. A biomass heating system for burning fuel in the form of pellets and/or wood chips, comprising:
a boiler with a combustion device,
a heat exchanger having a plurality of boiler tubes,
wherein the combustion device comprises the following:
a combustion chamber with a rotating grate, with a primary combustion zone and with a secondary combustion zone;
wherein the primary combustion zone is enclosed by the rotating grate from below;
wherein the primary combustion zone and the secondary combustion zone are separated by a combustion chamber nozzle;
wherein the secondary combustion zone of the combustion chamber is fluidically connected to an inlet of the heat exchanger;
wherein the primary combustion zone is laterally enclosed by a plurality of combustion chamber bricks and wherein the primary combustion zone has an oval horizontal cross-section.

2. The biomass heating system according to claim 1, wherein the horizontal cross-section of the primary combustion zone is designed to be at least approximately constant over a height of at least 100 mm.

3. The biomass heating system according to claim 1, wherein the combustion chamber in the secondary combustion zone has a combustion chamber slope that tapers the cross section of the secondary combustion zone in the direction of the inlet of the heat exchanger.

4. The biomass heating system according to claim 1, wherein the rotating grate has a first rotating grate element, a secondary rotating grate element and a third rotating grate element, each being designed to be able to rotate by at least 90 degrees around horizontally arranged bearing axis;
wherein the rotating grate elements form a combustion surface for the fuel;
wherein the rotating grate elements possess openings for the air for combustion,
wherein the first rotating grate element and the third rotating grate element have an identically shaped combustion surface.

5. The biomass heating system according to claim 4, wherein
the second rotating grate element is positively arranged between the first rotating grate element and the third rotating grate element and has grate lips that are arranged such that in a horizontal position of all three rotating grate elements they bear at least largely sealingly against the first rotating grate element and the third rotating grate element.

6. The biomass heating system according to claim 4, wherein
the rotating grate further comprises a rotating grate mechanism which is configured in such a way that it can rotate the third rotating grate element independently of the first rotating grate element and the second rotating grate element, and that it can rotate the first rotating grate element and the second rotating grate element together with one another and independently of the third rotating grate element.

7. The biomass heating system according to claim 4, wherein
the combustion surface of the rotating grate elements configures a substantially oval or elliptical combustion surface.

8. The biomass heating system according to claim 4, wherein
the rotating grate elements have mutually complementary and curved sides,
wherein preferably the second rotating grate element has concave sides to each of the adjacent first and third rotating grate element, and preferably the first and third rotating grate elements each have a convex side towards the second rotating grate element.

9. The biomass heating system according to claim 1, wherein
the combustion bricks have a modular structure; and
each two largely symmetrical combustion chamber bricks form a closed ring so as to form the primary combustion zone; and
at least two rings of combustion chamber bricks are stacked one on top of the other.

10. The biomass heating system according to claim 1, wherein
the heat exchanger has spiral turbulators arranged in the boiler tubes which extend over the entire length of the boiler tubes; and
the heat exchanger has belt turbulators arranged in the boiler tubes which extend over at least half the length of the boiler tubes.

11. The biomass heating system according to claim 1, wherein
the heat exchanger has between 18 and 24 boiler tubes, each with a diameter of 70 to 85 mm and a wall thickness of 3 to 4 mm.

12. The biomass heating system according to claim 1, wherein
the boiler has an integrated electrostatic filter device that has an electrode and a cage;
wherein the boiler additionally has a mechanically operated cleaning device with a rocking lever with a stop head;
wherein the cleaning device is designed such that it can strike the electrode as its end with the stop head so that a shock wave is generated through the electrode and/or transverse vibrations of the electrode are generated in order to clean the electrode of contaminants.

13. The biomass heating system according to claim 1, wherein a cleaning device is integrated into the boiler in the cold area, and which is configured in such a way that it can clean the boiler tubes of the heat exchanger by an upward and downward movement of turbulators provided in the boiler tubes.

14. The biomass heating system according to claim 1, wherein a glow bed height measuring mechanism is arranged in the combustion chamber above the rotating grate;
wherein the glow bed height measuring mechanism has fuel level flap with a main surface;
wherein a surface parallel of the main surface of the fuel level flap is provided at an angle of preferably greater than 20 degrees to a central axis of the axis of rotation.

15. The biomass heating system according to claim 4, wherein
the rotating grate elements have maximum external dimensions, such that they have a main axis of 288 mm+/−40 mm and a minor axis of 350 mm+/−60 mm, and wherein the primary combustion zone over a height of at least 400 mm preferably has the same minimum cross-section as the rotating grate elements.
